(19) United States
(12) Patent Application Publication
(10) Pub. No.: US 2017/0330235 A1
(43) Pub. Date: Nov. 16, 2017

(54) CUSTOMER MANAGEMENT SYSTEM FOR DETERMINING AGGREGATE CUSTOMER VALUE

(71) Applicant: Accenture Global Services Limited, Dublin (IE)

(72) Inventors: Rajneesh PATHAK, Bangalore (IN); Cauvery SHARMA, New Delhi (IN); Mayank VERMA, Gurgaon (IN); Athina KANIOURA, Athens (GR); Praveen KUMAR, Bangalore (IN); Gautam GOGOI, New Guwahati, Guwahati (IN); Archana MANGTANI, Gurgaon, Haryana (IN); Harsiddhi TAMBOLI, Nimbahera (IN); Sneha CHATE, Bhopal, Madhya Pradesh (IN)

(21) Appl. No.: 15/527,991

(22) PCT Filed: Feb. 25, 2015
(86) PCT No.: PCT/GR2015/000009

§ 371 Date: May 18, 2017

(51) Int. Cl. G06Q 30/02; G06Q 30/00

(52) U.S. Cl. CPC G06Q 30/0255; G06Q 30/0224; G06Q 30/01; G06Q 30/0211

(57) ABSTRACT

A device may receive information that identifies a customer and that identifies a start date, a zero date, and an end date. The device may determine a historical customer value associated with the customer during a first time period from the start date to the zero date. The device may determine an existing products value projected to be generated by the customer during a second time period from the zero date to the end date. The device may determine a new products value projected to be generated by the customer during the second time period. The device may determine an aggregate customer value associated with the customer based on the historical customer value, the existing products value, and the new products value. The device may transmit, based on the aggregate customer value, a message that causes an action to be performed to benefit the customer.

### BACKGROUND

A customer management system may manage a company's interactions with current and future customers. The customer management system may include technology to organize, automate, and/or synchronize sales, marketing, customer service, technical support, or the like.

### SUMMARY

According to some possible implementations, a device may include one or more processors to receive information that identifies a customer and that identifies a start date, a zero date, and an end date. The one or more processors may determine a historical customer value that is an actual profit generated by the customer during a first time period extending from the start date to the zero date. The one or more processors may determine an existing products value that is a first projected profit, associated with financial products held by the customer on the zero date, projected to be generated by the customer during a second time period extending from the zero date to the end date. The one or more processors may determine a new products value that identifies a second projected profit, associated with financial products the customer is likely to accept during the second time period, projected to be generated by the customer during the second time period. The one or more processors may determine an aggregate customer value associated with the customer based on the historical customer value, the existing products value, and the new products value. The one or more processors may transmit, based on the aggregate customer value, a message that causes an action to be performed to benefit the customer.

According to some possible implementations, a computer-readable medium may store instructions that, when executed by a processor, cause the processor to receive information that identifies a customer and that identifies a start date, a zero date, and an end date. The instructions may cause the processor to determine a historical customer value that is an actual profit generated by the customer during a first time period extending from the start date to the zero date. The instructions may cause the processor to determine an existing products value that is a first projected profit, associated with financial products held by the customer on the zero date, projected to be generated by the customer during a second time period extending from the zero date to the end date. The instructions may cause the processor to determine a new products value that identifies a second projected profit, associated with financial products the customer is likely to accept during the second time period, projected to be generated by the customer during the second time period. The instructions may cause the processor to determine an aggregate customer value associated with the customer by combining the historical customer value, the existing products value, and the new products value. The instructions may cause the processor to selectively provide an instruction to cause an action to be performed, to benefit the customer, based on the aggregate customer value.

According to some possible implementations, a method may include receiving, by a device, information that identifies a customer and that identifies a start date, a zero date, and an end date. The method may include determining, by the device, a historical customer value that is an actual profit generated by the customer during a first time period extending from the start date to the zero date. The method may include determining, by the device, an existing products value that is a first projected profit, associated with financial products held by the customer on the zero date, projected to be generated by the customer during a second time period extending from the zero date to the end date. The method may include determining, by the device, a new products value that identifies a second projected profit, associated with financial products the customer is likely to accept during the second time period, projected to be generated by the customer during the second time period. The method may include determining, by the device, an aggregate customer value associated with the customer based on the historical customer value, the existing products value, and the new products value. The method may include transmitting a message, by the device, to cause an action to be performed to benefit the customer, based on the aggregate customer value.

### BRIEF DESCRIPTION OF THE DRAWINGS

FIGS. 1A and 1B are diagrams of an overview of an example implementation described herein;

FIG. 2 is a diagram of an example environment in which systems and/or methods, described herein, may be implemented;

FIG. 3 is a diagram of example components of one or more devices of FIG. 2;

FIG. 4 is a flow chart of an example process for receiving financial information associated with calculating an aggregate customer value and/or receiving information that identifies a customer for whom the aggregate customer value is to be calculated;

FIGS. 5A-5C are diagrams of an example implementation relating to the example process shown in FIG. 4;

FIG. 6 is a flow chart of an example process for determining a historical customer value associated with a customer;

FIG. 7 is a diagram of an example implementation relating to the example process shown in FIG. 6;

FIG. 8 is a flow chart of an example process for determining an existing products value associated with a customer;

FIGS. 9A-9C are diagrams of an example implementation relating to the example process shown in FIG. 8;

FIG. 10 is a flow chart of an example process for determining a new products value associated with a customer;

FIG. 11 is a diagram of an example implementation relating to the example process shown in FIG. 10;

FIG. 12 is a flow chart of an example process for determining an aggregate customer value associated with a customer and/or performing an action based on the aggregate customer value; and

FIG. 13 is a diagram of an example implementation relating to the example process shown in FIG. 12.

### DETAILED DESCRIPTION

The following detailed description of example implementations refers to the accompanying drawings. The same reference numbers in different drawings may identify the same or similar elements.

A bank may focus on increasing sales of a financial product (e.g., a checking account, a mortgage, an insurance policy, or the like). The bank's focus on a specific financial product may cause the bank to lose focus on a customer relationship as a whole. As a result of a lack of focus on the customer relationship as a whole, the bank may not have an adequate understanding of evolving customer needs.

Implementations described herein may include a consultant server that comprehensively analyzes a customer's relationship with a bank by determining an aggregate customer value (e.g., revenue generated from a customer during an aggregate time period, which covers a part of the past and/or a part of the future, minus cost incurred by a bank to serve the customer during the aggregate time period) based on a historical customer value, an existing products value, and/or a new products value. Implementations described herein may determine an aggregate customer value (ACV) at a level of an individual customer (e.g., rather than at a level of a financial product, a demographic segment, or the like) and may use channel-level cost distribution (e.g., apportioning operating costs of a bank to a customer based on a medium of interaction, such as online banking or over the counter, that the customer uses to interact with the bank) to determine the ACV. With a proper understanding of evolving customer needs based on the ACV, the bank may reduce customer attrition and/or efficiently use the bank's marketing resources in targeting customers—thereby improving the bank's profitability.

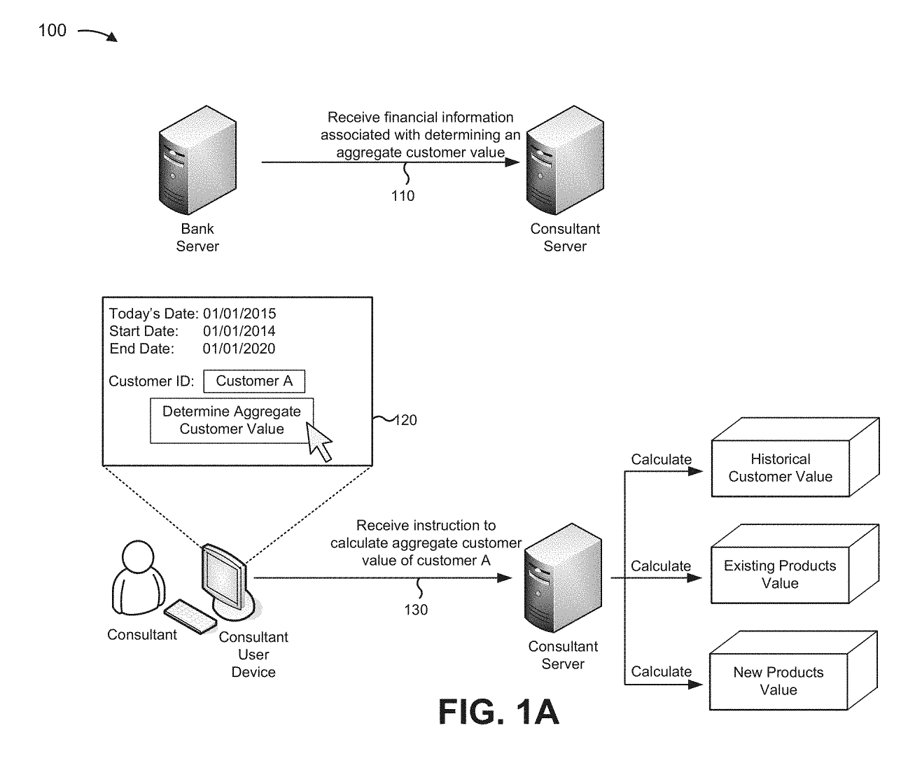

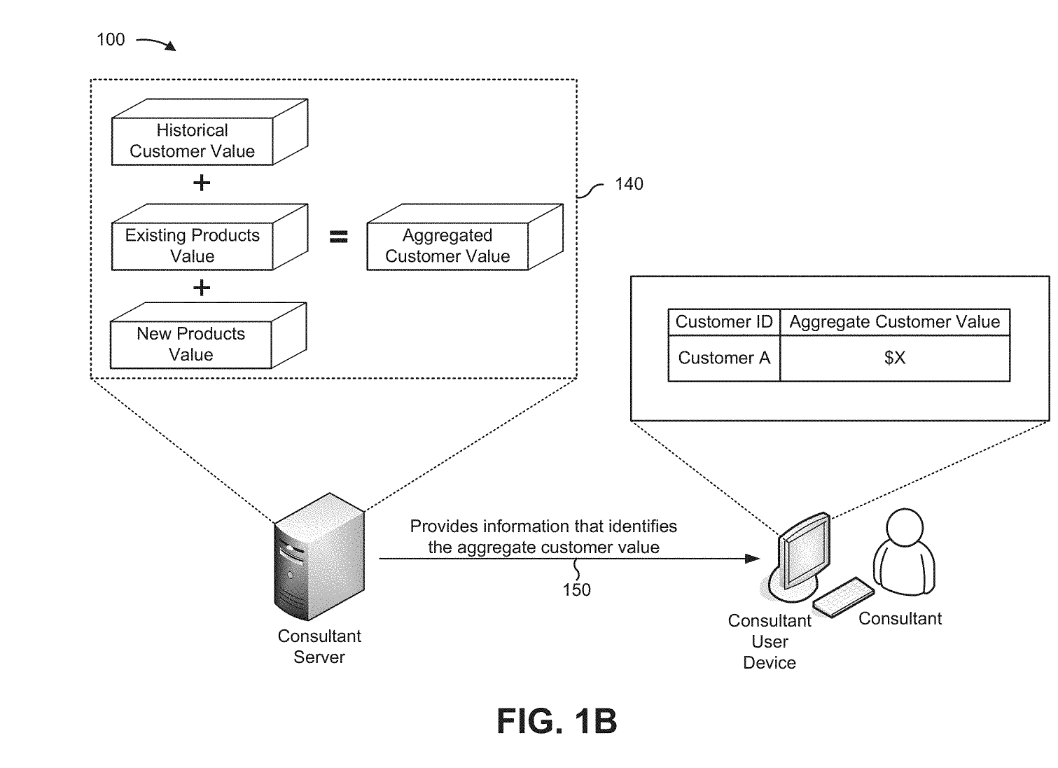

FIGS. 1A and 1B are diagrams of an overview of an example implementation 100 described herein. Assume that example implementation 100 includes a consultant server (e.g., a content server, a cloud-based server, or the like), a bank server which belongs to a bank (e.g., a content server, a cloud-based server, or the like), and a consultant user device (e.g. a desktop computer, a laptop computer, or the like) being used by a consultant.

As shown in FIG. 1A and as shown by reference number 110, the consultant server may receive, from the bank server, financial information associated with determining an ACV (e.g., the financial information includes account data such as account balance, customer data such as customer risk scores, product offer data such as offer description, or the like). As shown by reference number 120, the consultant user device may receive input, from a consultant, that identifies a customer for whom the ACV is to be calculated (for example, “Customer A”), a start date of an aggregate time period for which the ACV is to be calculated (for example, Jan. 1, 2014), and an end date of the aggregate time period (for example, Jan. 1, 2020). As further shown, the consultant may input an instruction to determine the ACV of Customer A (e.g., by clicking on a button, on a user interface of the consultant user device, that says “Determine Aggregate Customer Value”). As shown, assume that the consultant inputs the instruction on Jan. 1, 2015.

As shown by reference number 130, the consultant server may receive an instruction to calculate the ACV of Customer A for the aggregate time period of Jan. 1, 2014 to Jan. 1, 2020. The consultant server may calculate the ACV based on calculating a historical customer value, an existing products value, and/or a new products value (e.g., these three values may be combined to calculate the ACV).

A historical customer value may refer to an actual profit generated by a customer during a historical period, which starts on a start date of the aggregate time period and ends on a date the ACV is calculated (e.g., a zero date). Profit may refer to revenue generated from a customer minus cost incurred by the bank to serve the customer. The historical period may cover the past year (e.g., from Jan. 1, 2014 to Jan. 1, 2015), or another time period. In order to calculate the historical customer value, the consultant server may determine which financial products were used by the customer during the historical period (e.g., assume that the customer used a credit card during the historical period).

The consultant server may calculate the historical customer value by subtracting costs incurred by the bank in connection with the credit card from revenue generated by the bank in connection with the credit card (e.g., the revenue may be generated from annual fees paid by the customer while the cost may be incurred from rewards paid out to the customer and/or operating expenses of the bank). The consultant server may determine the cost incurred by the bank based on apportioning a part of the operating expenses of the bank based on information that identifies how often the customer used a particular medium of interaction with the bank (e.g., customers who often visit a physical branch may be apportioned more operating expenses than customers who mostly interact with the bank via online banking).

An existing products value may refer to a projected profit, during a projection period which starts on the zero date and ends on the end date, expected from a customer based on financial products already held by the customer (e.g., a projection period of five years, from Jan. 1, 2015 to Jan. 1, 2020). The consultant server may calculate the existing products value by subtracting projected cost incurred by the bank in connection with the credit card from projected revenue generated by the bank in connection with the credit card (e.g., the projected revenue may be based on probabilistic estimates of annual fees paid by the customer in future years while the projected cost may be based on probabilistic estimates of rewards paid out to the customer in future years and/or operating expenses of the bank in future years). In addition, the consultant server may calculate the existing products value based on a probabilistic estimate of customer attrition from a financial product. In addition, the consultant server may discount profits associated with future years to account for the time value of money.

A new products value may refer to a projected profit, during the projection period, expected from a customer based on new financial products that the customer may acquire during the projection period. The consultant server may calculate the new products value using techniques similar to techniques used during calculation of the existing products value. Additionally, or alternatively, the consultant server may calculate the new products value based on customer A's propensity to buy a new product.

As shown in FIG. 1B and as shown by reference number 140, the consultant server may determine the ACV by combining the historical customer value, the existing products value, and the new products value. As shown by reference number 150, the consultant server may provide, to the consultant user device, information that identifies the ACV. The consultant user device may display, on a user interface of the consultant user device, the ACV associated with Customer A. In some implementations, the consultant server may perform an action such as assigning a product offer or a membership benefit to Customer A's account based on the ACV and based on a customer relationship policy.

In this way, the consultant server may determine an aggregate customer value at a level of an individual customer and using channel-level cost distribution. With a proper understanding of evolving customer needs based on the aggregate customer value, the bank may reduce customer attrition and/or efficiently use the bank's marketing resources in targeting customers—thereby improving the bank's profitability.

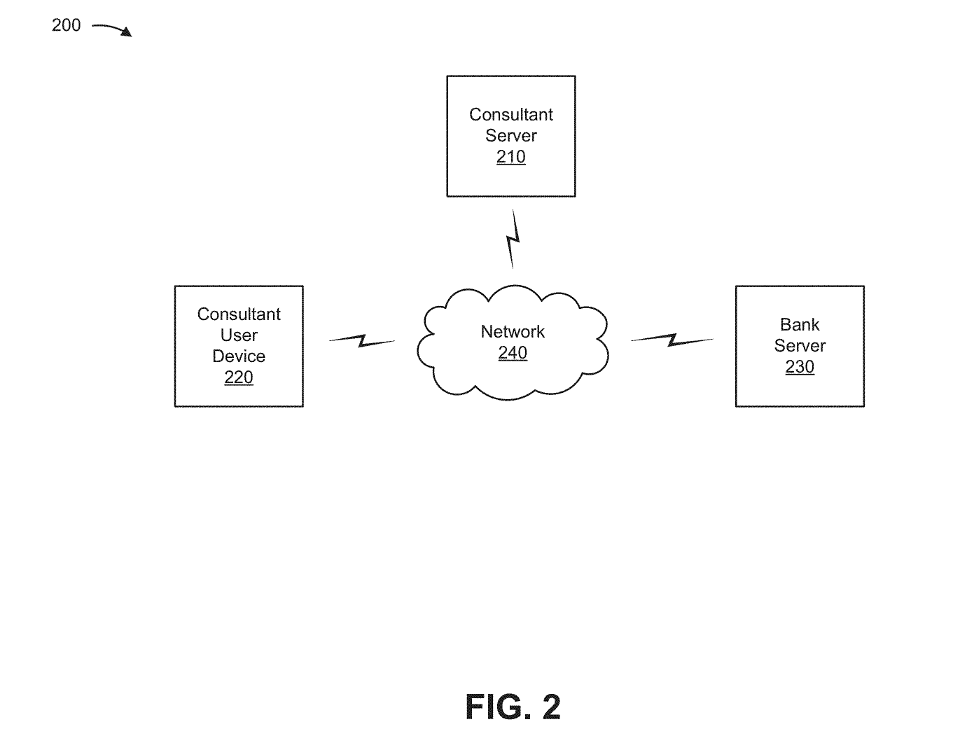

FIG. 2 is a diagram of an example environment 200 in which systems and/or methods, described herein, may be implemented. As shown in FIG. 2, environment 200 may include a consultant server 210, a consultant user device 220, a bank server 230, and a network 240. Devices of environment 200 may interconnect via wired connections, wireless connections, or a combination of wired and wireless connections.

Consultant server 210 may include one or more devices capable of receiving, storing, processing, and/or providing information. For example, consultant server 210 may include a computing device, such as a server (e.g., a cloud-based server, an application server, a content server, a host server, a web server, etc.), a desktop computer, or a similar device. In some implementations, consultant server 210 may determine an aggregate customer value associated with a customer. Additionally, or alternatively, consultant server 210 may be implemented as a hundred, a thousand, or more servers, included in a cloud computing environment, capable of processing financial information that includes billions of values associated with millions of customers (e.g., using big data analytics).

Consultant user device 220 may include one or more devices capable of receiving, storing, processing, and/or providing information. For example, consultant user device 220 may include a computing device, such as a laptop computer, a tablet computer, a handheld computer, a desktop computer, a mobile phone (e.g., a smart phone, a radiotelephone, etc.), or a similar device. In some implementations, consultant user device 220 may display a user interface. Additionally, or alternatively, consultant user device 220 may receive input from a consultant (e.g., a user).

Bank server 230 may include one or more devices capable of receiving, storing, processing, and/or providing information. For example, bank server 230 may include a server (e.g., a cloud-based server, an application server, a content server, a host server, a web server, etc.), a desktop computer, or a similar device. In some implementations, bank server 230 may provide financial information to consultant server 210.

Network 240 may include one or more wired and/or wireless networks. For example, network 240 may include a wireless local area network (WLAN), an intranet, the Internet, a fiber optic-based network, a local area network (LAN), a wide area network (WAN), a metropolitan area network (MAN), a telephone network (e.g., the Public Switched Telephone Network (PSTN)), a cellular network, a public land mobile network (PLMN), an ad hoc network, or a combination of these or other types of networks.

The number and arrangement of devices shown in FIG. 2 are provided as an example. In practice, there may be additional devices, fewer devices, different devices, or differently arranged devices than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

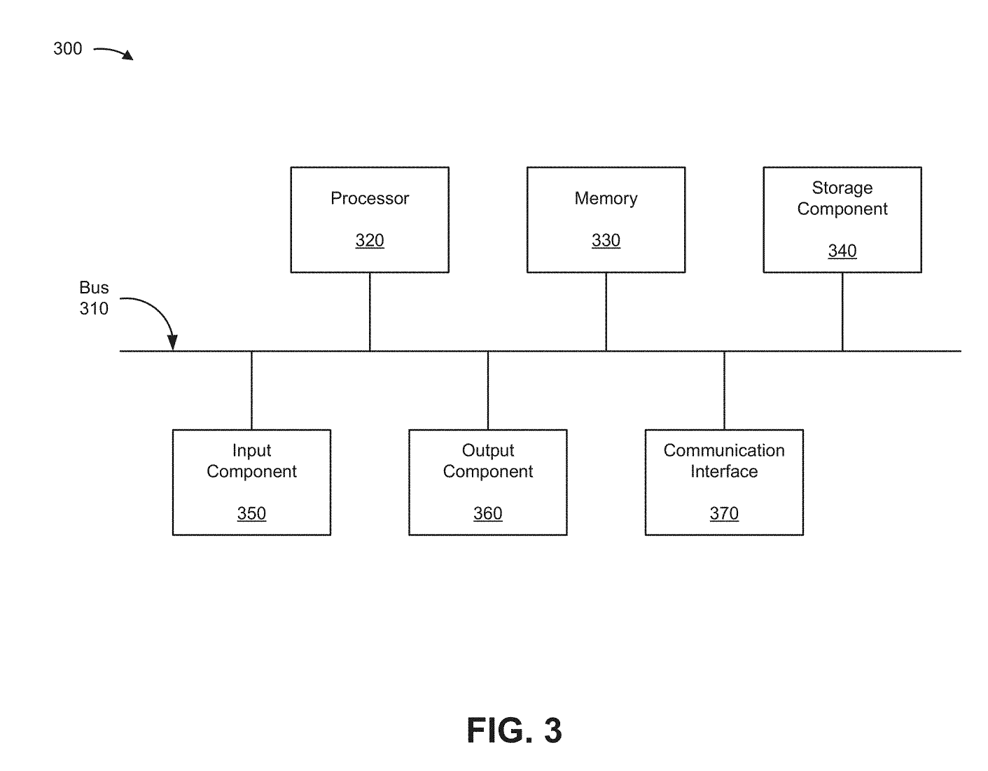

FIG. 3 is a diagram of example components of a device 300. Device 300 may correspond to consultant server 210, consultant user device 220, and/or bank server 230. In some implementations, consultant server 210, consultant user device 220, and/or bank server 230 may include one or more devices 300 and/or one or more components of device 300. As shown in FIG. 3, device 300 may include a bus 310, a processor 320, a memory 330, a storage component 340, an input component 350, an output component 360, and a communication interface 370.

Bus 310 may include a component that permits communication among the components of device 300. Processor 320 is implemented in hardware, firmware, or a combination of hardware and software. Processor 320 may include a processor (e.g., a central processing unit (CPU), a graphics processing unit (GPU), an accelerated processing unit (APU), etc.), a microprocessor, and/or any processing component (e.g., a field-programmable gate array (FPGA), an application-specific integrated circuit (ASIC), etc.) that interprets and/or executes instructions. Memory 330 may include a random access memory (RAM), a read only memory (ROM), and/or another type of dynamic or static storage device (e.g., a flash memory, a magnetic memory, an optical memory, etc.) that stores information and/or instructions for use by processor 320.

Storage component 340 may store information and/or software related to the operation and use of device 300. For example, storage component 340 may include a hard disk (e.g., a magnetic disk, an optical disk, a magneto-optic disk, a solid state disk, etc.), a compact disc (CD), a digital versatile disc (DVD), a floppy disk, a cartridge, a magnetic tape, and/or another type of computer-readable medium, along with a corresponding drive.

Input component 350 may include a component that permits device 300 to receive information, such as via user input (e.g., a touch screen display, a keyboard, a keypad, a mouse, a button, a switch, a microphone, etc.). Additionally, or alternatively, input component 350 may include a sensor for sensing information (e.g., a global positioning system (GPS) component, an accelerometer, a gyroscope, an actuator, etc.). Output component 360 may include a component that provides output information from device 300 (e.g., a display, a speaker, one or more light-emitting diodes (LEDs), etc.).

Communication interface 370 may include a transceiver-like component (e.g., a transceiver, a separate receiver and transmitter, etc.) that enables device 300 to communicate with other devices, such as via a wired connection, a wireless connection, or a combination of wired and wireless connections. Communication interface 370 may permit device 300 to receive information from another device and/or provide information to another device. For example, communication interface 370 may include an Ethernet interface, an optical interface, a coaxial interface, an infrared interface, a radio frequency (RF) interface, a universal serial bus (USB) interface, a Wi-Fi interface, a cellular network interface, or the like.

Device 300 may perform one or more processes described herein. Device 300 may perform these processes in response to processor 320 executing software instructions stored by a computer-readable medium, such as memory 330 and/or storage component 340. A computer-readable medium is defined herein as a non-transitory memory device. A memory device includes memory space within a single physical storage device or memory space spread across multiple physical storage devices.

Software instructions may be read into memory 330 and/or storage component 340 from another computer-readable medium or from another device via communication interface 370. When executed, software instructions stored in memory 330 and/or storage component 340 may cause processor 320 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 3 are provided as an example. In practice, device 300 may include additional components, fewer components, different components, or differently arranged components than those shown in FIG. 3. Additionally, or alternatively, a set of components (e.g., one or more components) of device 300 may perform one or more functions described as being performed by another set of components of device 300.

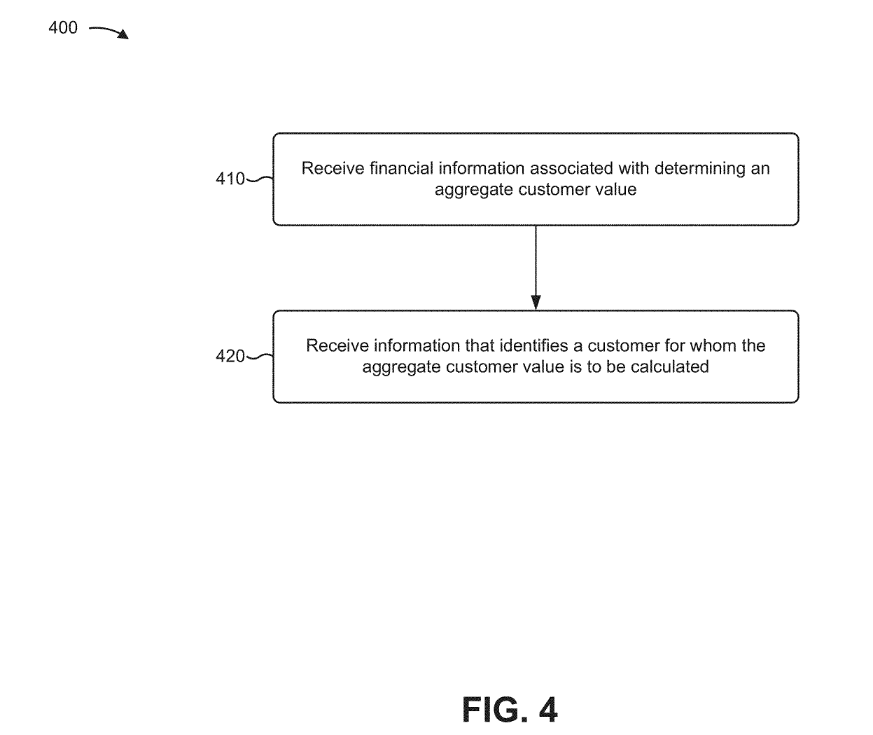

FIG. 4 is a flow chart of an example process 400 for receiving financial information associated with calculating an aggregate customer value and/or receiving information that identifies a customer for whom the aggregate customer value is to be calculated. In some implementations, one or more process blocks of FIG. 4 may be performed by consultant server 210. In some implementations, one or more process blocks of FIG. 4 may be performed by another device or a set of devices separate from or including consultant server 210, such as consultant user device 220 and/or bank server 230.

As shown in FIG. 4, process 400 may include receiving financial information associated with determining an aggregate customer value (block 410). For example, consultant server 210 may receive financial information from bank server 230. In some implementations, consultant server 210 may receive, from consultant user device 220 (e.g., which may have received an input from a consultant), an instruction to begin a process of gathering the financial information. Additionally, or alternatively, consultant server 210 may provide, to bank server 230, a request for the financial information. Additionally, or alternatively, bank server 230 may provide the financial information to consultant server 210.

In some implementations, consultant user device 220 may provide a request for the financial information to bank server 230, which may provide the financial information to consultant user device 220 and/or consultant server 210. In some implementations, consultant server 210 may receive financial information associated with a large quantity (e.g., millions, hundreds of millions, or more) of customers.

In some implementations, the financial information may include account data that identifies financial figures (an average balance, an outstanding balance, an average spending, etc.) associated with various financial products at an account level. Financial products may include a current account (e.g., a transactional account, which includes an overdraft facility commonly used by customers, often found in the United Kingdom), a demand account (e.g., a checking account), a notice account (e.g., a savings account where a customer must give notice a specified period of time before withdrawal to avoid penalties), a term account (e.g., a savings account where a customer's funds are released to the customer after a specified term), a term loan, a mortgage, a credit card, an insurance policy, or the like. For example, the financial information may include account data that identifies an account number and an average balance of a customer's demand account for a certain year.

In some implementations, the financial information may include customer data that includes information at a customer level. In some implementations, customer data may include information that identifies a customer risk score (e.g., an indicator, based on the customer's credit score, of the customer's likelihood to default on an obligation to the bank, such as an obligation to make payments in connection with a loan, a mortgage, a credit card, or the like). Additionally, or alternatively, the customer data may include information that identifies a quantity of transactions, associated with a customer, corresponding to different channels of communication between a bank and a customer (e.g., a quantity of over the counter transactions associated with a customer, a quantity of phone transactions associated with a customer, a quantity of ATM transactions associated with a customer, a quantity of internet/mobile transactions associated with a customer, or the like).

In some implementations, the financial information may include product offer data that identifies information associated with a product offer. In some implementations, product offer data may include a name of a product offer, a description of a product offer, or the like.

In some implementations, the financial information may include business data that identifies indicators that apply across various customers, such as product-specific profit margins, interchange rates (e.g., fees a bank receives from a merchant when a customer uses a credit card or another financial product in a transaction with the merchant), a quantity of transactions associated with a communication channel, or the like. Additionally, or alternatively, the financial information may include business data that identifies indicators that apply to a product offer. Additionally, or alternatively, the business data may include rates of growth associated with financial products in use and/or financial products associated with a product offer (e.g., the rates of growth may be determined using probabilistic methods and/or inputs from bank employees that indicate the future popularity of a particular financial product).

In some implementations, the financial information may include information that identifies revenue drivers and cost drivers associated with financial products. In some implementations, revenue drivers may include interest income, interchange income (e.g., income from fees a bank receives from a merchant when a customer uses a credit card or another financial product in a transaction with the merchant), annual fees, commission, assessment (e.g., one time fees charged to a customer at a time of loan or mortgage origination), income from balance leveraging (e.g., a profit derived from a bank's use of deposited customer funds), or the like. Additionally, or alternatively, cost drivers may include cost of funds (e.g., a cost a bank incurs in obtaining money that the bank lends to a customer), credit provisioning (e.g., a cost a bank incurs because a customer may not pay an obligation), rewards expense, operating expense, or the like. Additionally, or alternatively, the financial information may include a formula for calculating a revenue and/or cost driver associated with a financial product (e.g., a mathematical formula based on financial figures associated with the financial products and/or based on business data that identifies indicators that apply across various customers). Additionally, or alternatively, the financial information may include any other information, that may be accessible to a bank, that may assist in calculating the ACV.

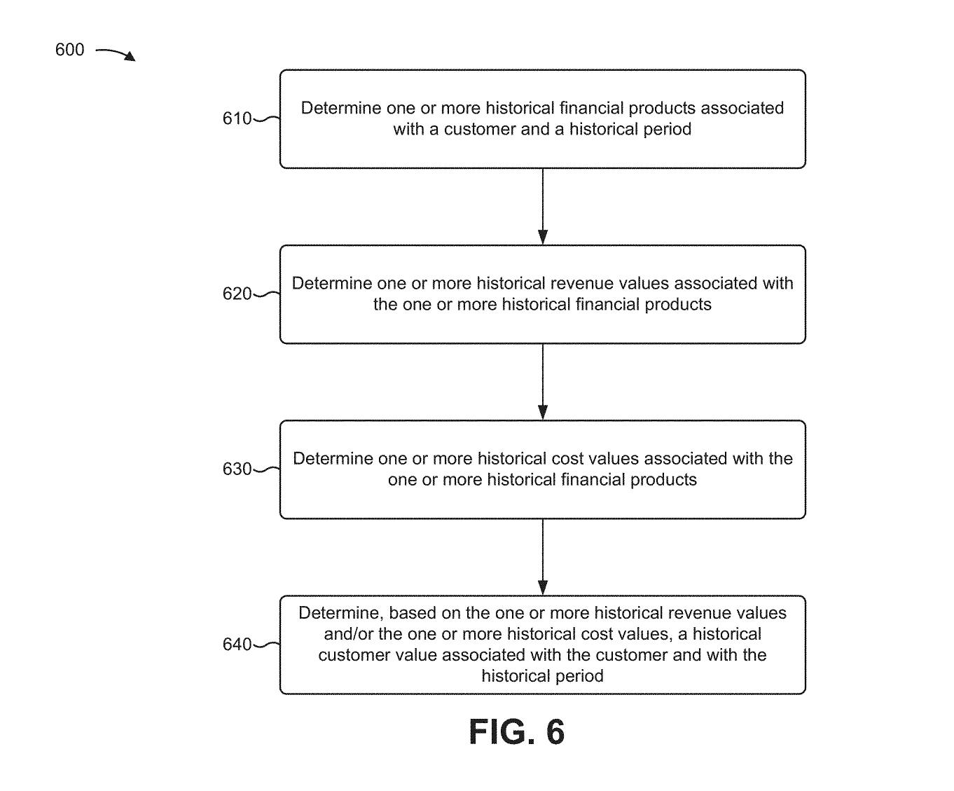

As further shown in FIG. 4, process 400 may include receiving information that identifies a customer for whom the aggregate customer value is to be calculated (block 420). For example, consultant server 210 may receive, from consultant user device 220, information that identifies a customer for whom the aggregate customer value is to be calculated. In some implementations, a consultant may input information, to consultant user device 220, that identifies the customer (e.g., a consultant may input a customer ID number). Additionally, or alternatively, a consultant may input information that identifies a start date of an aggregate time period and an end date of the aggregate time period (e.g., the aggregate time period for which the ACV is to be calculated). Additionally, or alternatively, a consultant may input an instruction, to consultant user device 220, to determine the ACV. Additionally, or alternatively, consultant user device 220 may provide the instruction to determine the ACV to consultant server 210 (e.g., which may calculate the ACV as described below in connection with FIGS. 6-13).

In some implementations, consultant server 210 may identify a customer automatically (e.g., without input from the consultant). Additionally, or alternatively, consultant server 210 may identify a customer, for calculation of the ACV, periodically (e.g., consultant server 210 may select a customer every 6 months, every year, every five years, or the like). Additionally, or alternatively, consultant server 210 may identify a customer based on a date on which the customer starting using the bank, based on a birthday associated with the customer, based on a date on which the customer accepted a large loan, or the like.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

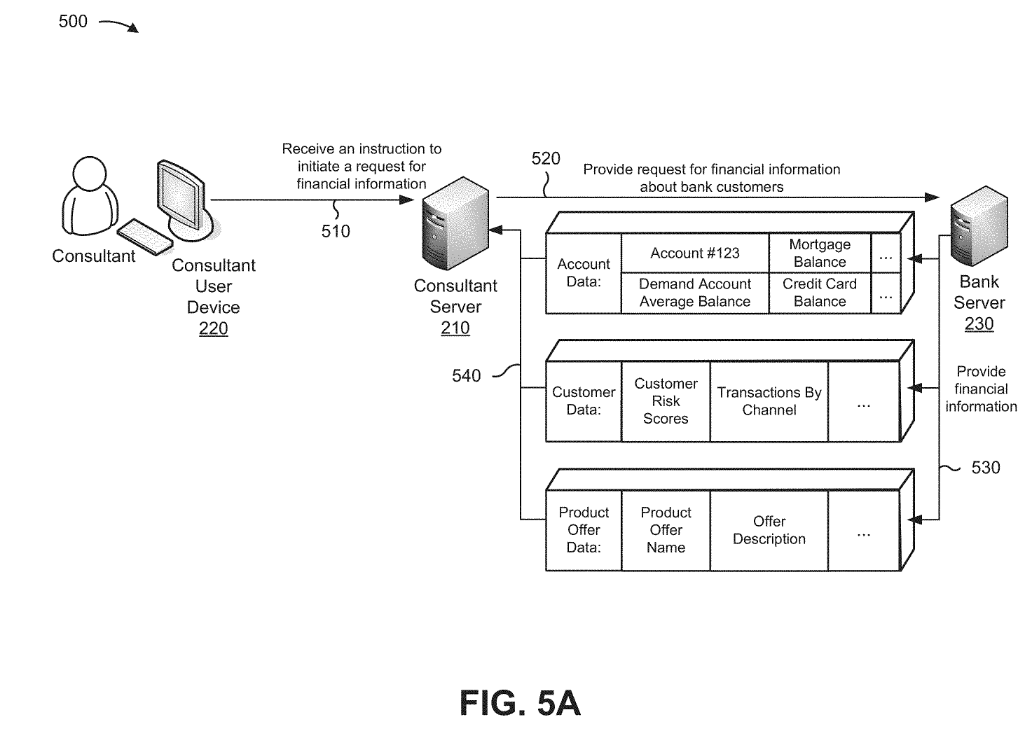

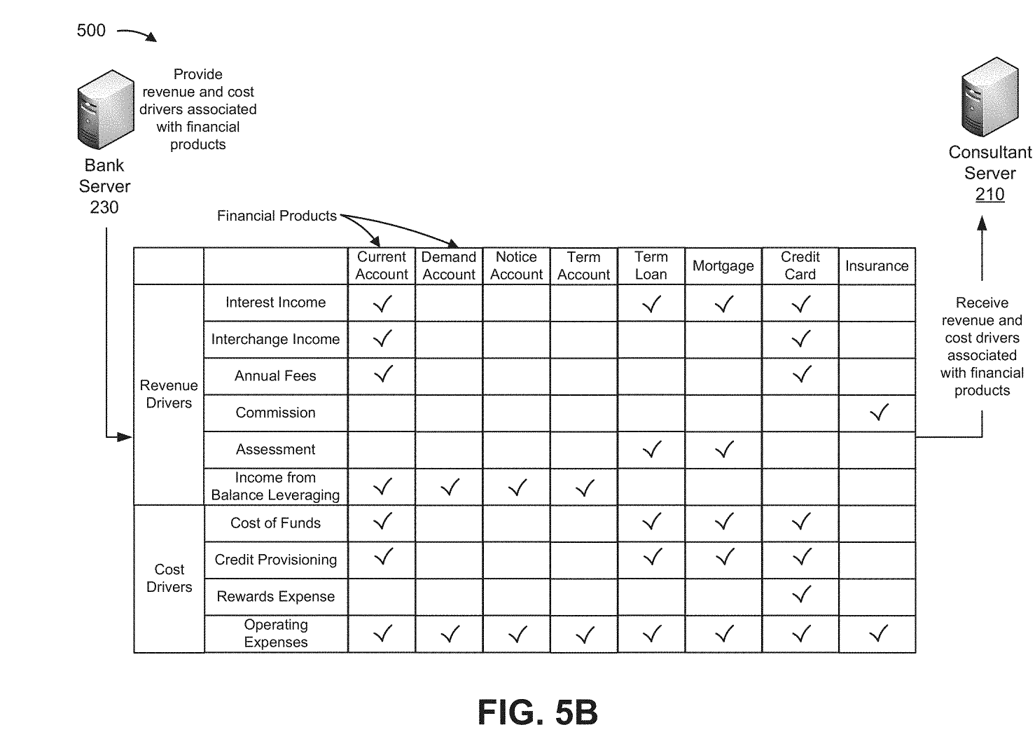

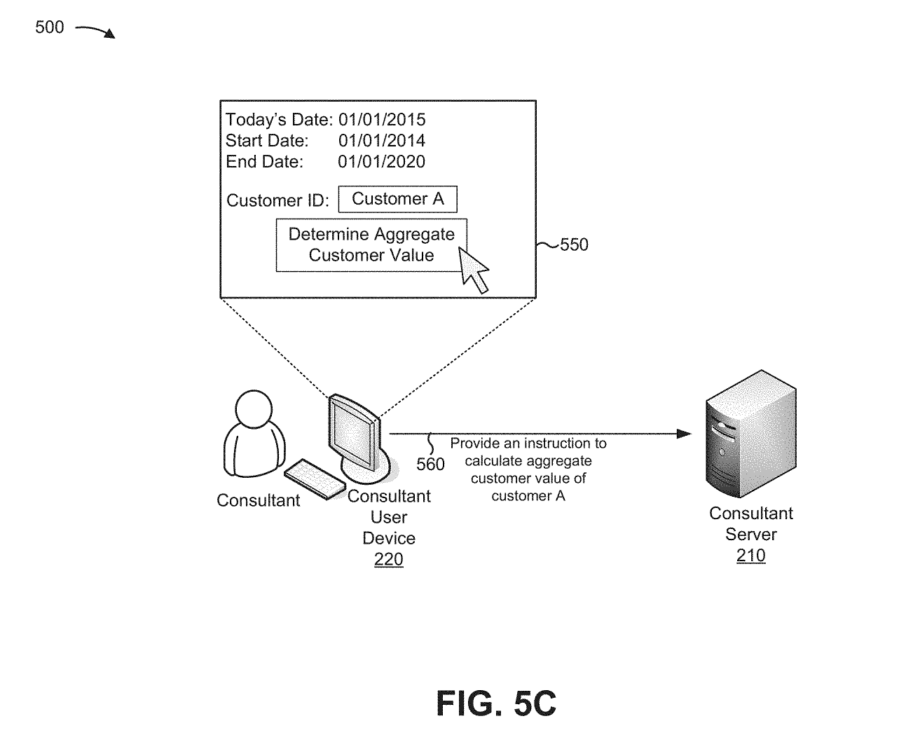

FIGS. 5A-5C are diagrams of an example implementation 500 relating to example process 400 shown in FIG. 4. FIGS. 5A-5C show an example of receiving financial information associated with calculating an aggregate customer value and/or receiving information that identifies a customer for whom the aggregate customer value is to be calculated. Assume that FIGS. 5A-5C include consultant server 210, consultant user device 220 being used by a consultant, and bank server 230.

As shown in FIG. 5A and as shown by reference number 510, consultant server 210 receives, from consultant user device 220 (e.g., which received an input from a consultant), an instruction to initiate a request for financial information. As shown by reference number 520, consultant server 210 provides, to bank server 230, a request for the financial information. As shown by reference number 530, bank server 230 provides the financial information. As shown, the financial information includes account data that identifies financial figures associated with various financial products at an account level (e.g., shown as “Demand Account Average Balance,” “Mortgage Balance,” “Credit Card Balance,” and other financial figures associated with “Account #123”). The financial information includes customer data that includes information at a customer level (e.g., shown as “Customer Risk Score” and “Transactions By Channel”). The financial information includes information associated with a product offer (e.g., shown as “Product Offer Data” that identifies “Product Offer Name” and “Offer Description”). Assume that the financial information includes business data (not shown). Assume further that consultant server 210 receives, from bank server 230, financial information associated with multiple customers.

As shown in FIG. 5B, bank server 230 provides, to consultant server 210, financial information that includes revenue drivers and cost drivers associated with financial products (e.g., bank server 230 may provide the revenue drivers and the cost drivers organized in a data structure, as shown). As shown, columns of the data structure identify financial products associated with customers. Bank server 230 may provide revenue and cost drivers corresponding to hundreds, thousands, or more financial products, but, for simplicity, eight financial products are shown in this example implementation (e.g., current account, demand account, notice account, etc.). Six rows of the data structure identify revenue drivers (e.g., interest income, interchange income, etc.) and four rows of the data structure identify cost drivers (e.g., cost of funds, credit provisioning, etc.). The data structure indicates, using checkmarks, revenue and cost drivers associated with a financial product (e.g., a term loan's revenue drivers are interest income and assessment, and a term loan's cost drivers are cost of funds, credit provisioning, and operating expense).

Assume further that bank server 230 provides, to consultant server 210, financial information that includes formulas for calculating revenue and/or cost drivers associated with financial products (not shown). Assume that operating expenses are a cost driver associated with the eight financial products listed below. Assume further that the financial information includes the following formulas for the eight financial products:
1. Current Account:
   Revenue Drivers:
      Interest Income=Interest Earned on Over Draft (OD)=Average OD Balance×Current OD Interest Rate
      Interchange Income=Interchange revenue on debit card transactions=Total Debit Card Spending×Debit card interchange rate
      Annual Fees=Total fees paid by the customer for the current account
      Income From Balance Leveraging=Average balance in the current account×Current Account Net Interest Margin (e.g., a margin or a difference between a return earned by a bank using deposited funds and interest paid to a customer for the deposited funds)
   Cost Drivers:
      Cost of Funds=Average OD Balance×Cost of funds rate
      Credit Provisioning=Loss provisioning on Current Account OD Balance=Customer Risk Score×Average OD Balance
2. Demand Account:
   Revenue Drivers:
      Income from balance leveraging=Average balance in demand account×Demand Account Net Interest Margin
3. Notice Account:
   Revenue Drivers:
      Income From Balance Leveraging=Average balance in notice account×Notice Account Net Interest Margin
4. Term Account:
   Revenue Drivers:
      Income from balance leveraging=Average balance in term account×Term Account Net Interest Margin
5. Term Loan:
   Revenue Drivers:
      Interest Income=Average outstanding balance for the Term Loan×Term Loan Interest Rate
      Assessment=Processing Fees=One time fees charged to the customer at the time of loan origination
   Cost Drivers:
      Cost of funds=Average outstanding balance for the Term Loan×Cost of funds rate
      Credit Provisioning=Loss provisioning=If the term loan tenure is greater than year for which loss provisioning is being calculated then loss provisioning is Customer Risk Score×Average outstanding balance for the Term Loan
6. Mortgage:
   Revenue Drivers:
      Interest Income=Average outstanding balance for mortgage×Mortgage Interest Rate
      Assessment=Processing Fees=One time fees charged to the customer at the time of loan origination
   Cost Drivers:
      Cost of funds=Average outstanding balance for mortgage×Cost of funds rate
      Credit Provisioning=Loss Provisioning=If the mortgage loan tenure is greater than year for which loss provisioning is being calculated then loss provisioning is Customer Risk Score×Average outstanding balance for the Mortgage Loan
7. Credit Card:
   Revenue Drivers:
      Interest Income=Finance charges=Average outstanding balance in credit card×(Credit Card Annual Percentage Rate+Prime Rate)
      Interchange Income=Total credit card spend×Credit Card Interchange Rate
      Annual Fees=Annual fees charged by the credit card company each year for use of credit card
   Cost Drivers:
      Cost of funds=Average outstanding balance in credit card×Cost of funds rate
      Credit Provisioning=Loss provisioning=Customer Risk Score×Average outstanding balance in the credit card
      Rewards Expense=Total credit card spending×Percentage rewards expense incurred by the bank
8. Insurance:
   Revenue Drivers:
      Commission for a new Life insurance policy=Annual premium of the life policy opened in the last 12 months×Net revenue margin of the life policy opened in the last 12 months
      Commission for a new non-Life insurance policy=Annual premium of the non-life policy opened in the last 12 months×Net revenue margin of the non-life policy opened in the last 12 months
      Commission for a renewed Life insurance policy=Annual premium of the life policy renewed in the last 12 months×Net revenue margin of the life policy renewed in the last 12 months
      Commission for a renewed non-Life insurance policy=Annual premium of the non-life policy renewed in the last 12 months×Net revenue margin of the non-life policy renewed in the last 12 months
         Formulas shown above may be used by consultant server 210 to calculate the aggregate customer value.

As shown in FIG. 5C and as shown by reference number 550, a consultant inputs information, to consultant user device 220, that identifies a customer for whom the aggregate customer value is to be calculated (e.g., shown as “Customer A”). As further shown, the consultant inputs information that identifies a start date of an aggregate time period (e.g., shown as “01/01/2014”) and an end date of the aggregate time period (e.g., shown as “01/01/2020”). As further shown, a consultant inputs an instruction, to consultant user device 220, to determine the ACV (e.g., shown as the consultant clicking on a button labeled “Determine Aggregate Customer Value”). As shown by reference number 560, consultant user device 220 may provide the instruction to determine the ACV to consultant server 210.

As indicated above, FIGS. 5A-5C are provided merely as an example. Other examples are possible and may differ from what was described with regard to FIGS. 5A-5C.

FIG. 6 is a flow chart of an example process 600 for determining a historical customer value associated with a customer. In some implementations, one or more process blocks of FIG. 6 may be performed by consultant server 210. In some implementations, one or more process blocks of FIG. 6 may be performed by another device or a set of devices separate from or including consultant server 210, such as consultant user device 220 and/or bank server 230.

As shown in FIG. 6, process 600 may include determining one or more historical financial products associated with a customer and a historical period (block 610). For example, consultant server 210 may determine, based on the financial information received from bank server 230, one or more historical financial products associated with a customer and a historical period (e.g., six months, a year, two years, from this date to that date, or the like). In some implementations, the historical period may refer to a time period that starts on the start date of the aggregate time period and ends on the zero date. Additionally, or alternatively, the one or more historical financial products may include financial products held by a customer during a historical period. For example, consultant server 210 may determine that customer A held a demand account and a mortgage during a historical period (e.g., during the past six months, the past year, the past two years, or the like). In some implementations, consultant server 210 may determine that a financial product that was held by a customer during the historical period, but is no longer held by the customer, is included in the one or more historical financial products.

As further shown in FIG. 6, process 600 may include determining one or more historical revenue values associated with the one or more historical financial products (block 620). For example, consultant server 210 may determine, based on financial information received from bank server 230, one or more historical revenue values associated with the one or more historical financial products (e.g., the financial information may identify a revenue driver and/or a formula to calculate the revenue driver). In some implementations, consultant server 210 may identify a revenue driver associated with the one or more historical financial products (e.g. income from balance leveraging for a demand account, interest income and assessment for a mortgage, or the like). Additionally, or alternatively, consultant server 210 may calculate a historical revenue value associated with a historical financial product using a formula.

For example, for a mortgage, consultant server 210 may calculate interest income by multiplying an average outstanding balance of the mortgage (e.g., during the historical period) with a mortgage interest rate (e.g., the average outstanding balance of the mortgage and the mortgage interest rate may have been included in financial information received from bank server 230). Additionally, or alternatively, for a mortgage, consultant server 210 may calculate assessment by identifying processing fees that are one time fees charged to a customer at a time of loan origination.

As further shown in FIG. 6, process 600 may include determining one or more historical cost values associated with the one or more historical financial products (block 630). For example, consultant server 210 may determine, based on financial information received from bank server 230, one or more historical cost values associated with the one or more historical financial products (e.g., the financial information may identify a cost driver and a formula to calculate the cost driver). In some implementations, consultant server 210 may identify a cost driver associated with the one or more historical financial products (e.g., cost of funds for a mortgage, credit provisioning for a mortgage, or the like). Additionally, or alternatively, consultant server 210 may calculate a historical cost value associated with a historical financial product using a formula.

For example, for a mortgage, consultant server 210 may calculate cost of funds by multiplying an average outstanding balance of the mortgage (e.g., during the historical period) with a cost of funds rate (e.g., the average outstanding balance of the mortgage and the cost of funds rate may have been included in financial information received from bank server 230).

In some implementations, consultant server 210 may determine one or more historical cost values, such as operating expenses, that are associated with multiple financial products (e.g., operating expense may be an aggregate historical cost value associated with a customer, rather than being associated with specific financial products held by a customer). In some implementations, consultant server 210 may determine operating expenses based on financial information received from bank server 230. In some implementations, consultant server 210 may determine a percentage contribution from a communication channel towards a bank's operating expenses (e.g., consultant server 210 may determine that over the counter contributes 75% of the operating expenses of the bank, phone/call center contributes 10%, ATM contributes 10%, internet/mobile contributes 5%, or the like). In some implementations, consultant server 210 may determine the percentage contribution based on information received from bank server 230, based on information received from consultant user device 220 (e.g., which may have received input from a consultant), and/or based on a mathematical formula stored by consultant server 210.

Additionally, or alternatively, consultant server 210 may determine operating expenses associated with a communication channel by multiplying a percentage contribution of a communication channel with total operating expenses of a bank (e.g., if total operating expenses of a bank were $1000 and a percentage contribution of over the counter is 75%, then the operating expenses associated with over the counter are $1000×0.75=$750). Numerical and/or mathematical examples provided herein are meant to be roughly illustrative and may be inexact for a variety of reasons (e.g., rounding to a small number of decimal places, converting repeating fractions to decimal notation, converting irrational numbers to decimal notation, or the like).

Additionally, or alternatively, consultant server 210 may determine a cost incurred by the bank per transaction for a communication channel by dividing operating expenses associated with a communication channel by a quantity of transactions performed via the communication channel (e.g., if the operating expenses associated with over the counter are $750 and there are 100 over the counter transactions, then a cost incurred by the bank per transaction for over the counter is $750/100=$7.50). Additionally, or alternatively, consultant server 210 may determine operating expenses of a customer associated with a communication channel by multiplying the cost incurred by the bank per transaction for the communication channel with a quantity of transactions performed by the customer via the communication channel (e.g., if the cost incurred by the bank per transaction for over the counter is $7.50 and a quantity of transactions performed by the customer via over the counter is three, then the operating expenses of the customer associated with over the counter are $7.50×3=$22.50).

In some implementations, consultant server 210 may determine, in the manner described above, operating expenses of a customer associated with communication channels used by the customer. Additionally, or alternatively, consultant server 210 may determine operating expenses associated with a customer by summing operating expenses of a customer associated with communication channels used by the customer (e.g., if operating expenses of a customer associated with over the counter are $22.50, associated with phone/call center are $5, associated with ATM are $0, and associated with internet/mobile are $10, then the operating expenses associated with the customer are $22.50+$5+$0+$10=$37.50).

As further shown in FIG. 6, process 600 may include determining, based on the one or more historical revenue values and/or the one or more historical cost values, a historical customer value associated with the customer and with the historical period (block 640). For example, consultant server 210 may determine a historical customer value associated with the customer and with the historical period. In some implementations, consultant server 210 may determine a pre-tax historical customer value by subtracting the one or more historical cost values from the one or more historical revenue values, and adjusting for taxation by subtracting a tax amount, based on a tax rate, from the pre-tax historical customer value.

For example, assume a customer's historical financial products include a demand account and a mortgage. Assume that an income from balance leveraging associated with the demand account is $50, that an interest income associated with the mortgage is $350, that an assessment associated with the mortgage is $0, that a cost of funds associated with the mortgage is $150, that credit provisioning associated with the mortgage is $40, and that operating expenses associated with the customer are $37.50. Assume further that tax is 35%. In such an example, consultant server 210 may determine that the historical customer value associated with the customer is $112.12 because ($50+$350+$0)−($150+$40+$37.50)=$172.50, $172.50×0.35=$60.38, $172.50−60.38=$112.12.

In this way, consultant server 210 may calculate a historical customer value, which may be used by consultant server 210 (e.g., in conjunction with an existing products value and/or a new products value) to determine an aggregate customer value associated with a customer.

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel.

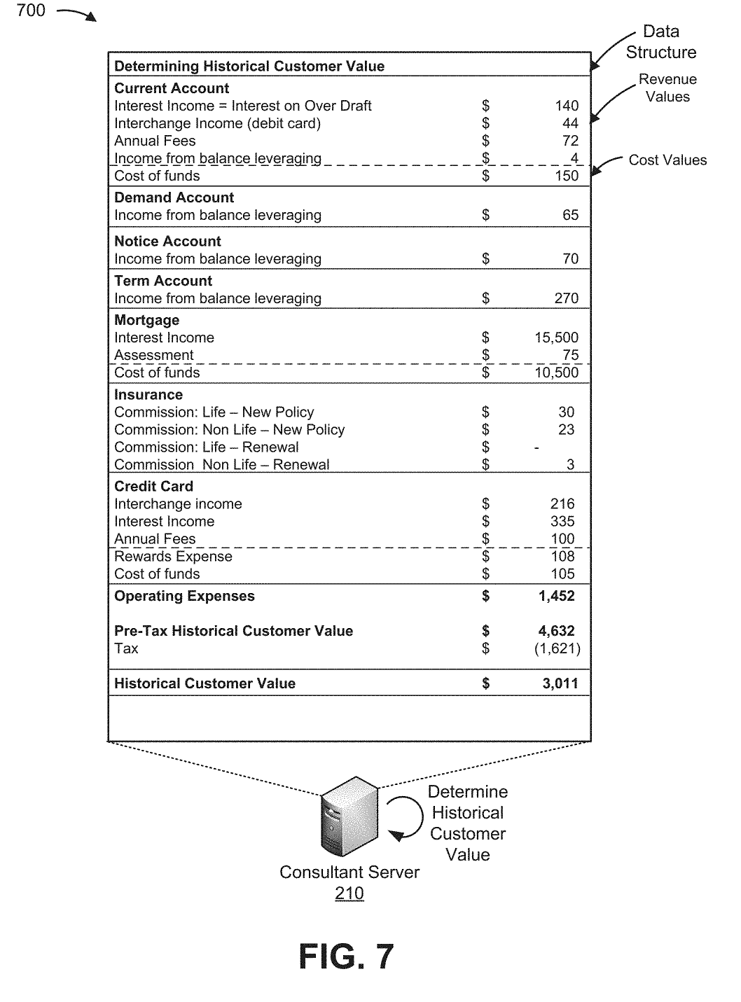

FIG. 7 is a diagram of an example implementation 700 relating to example process 600 shown in FIG. 6. FIG. 7 shows an example of determining a historical customer value associated with a customer.

As shown in FIG. 7, assume that example implementation 700 includes consultant server 210 that has received financial information associated with determining an aggregate customer value and/or has received information that identifies a customer for whom the aggregate customer value is to be calculated (as described above in connection with FIGS. 5A-5C). Assume further that Customer A is the customer for whom ACV is to be calculated and that a start date of the aggregate period is Jan. 1, 2014, a zero date (e.g., a date on which the ACV is being calculated) is Jan. 1, 2015, and an end date of the aggregate period is Jan. 1, 2020.

Consultant server 210 determines historical financial products associated with Customer A during a historical period (e.g., a one year period from Jan. 1, 2014 to Jan. 1, 2015). As shown in a data structure stored by consultant server 210, the historical financial products are current account, demand account, notice account, term account, mortgage, insurance, and credit card. Consultant server 210 determines historical revenue values associated with the historical financial products (e.g., based on revenue drivers received from bank server 230 and/or formulas, associated with a revenue driver, received from bank server 230). As shown, consultant server 210 determines that an interest income associated with a current account is $140, an interchange income associated with the current account is $44, annual fees associated with the current account are $72, an income from balance leveraging associated with the current account is $4, an income from balance leveraging associated with a demand account is $65, and so on. Consultant server 210 determines that the sum of the revenue values is $16,947 (not shown).

Consultant server 210 determines historical cost values associated with the historical financial products (e.g., cost values are shown below a dotted line). As shown, consultant server 210 determines that a cost of funds associated with the current account is $150, a cost of funds associated with a mortgage is $10,500, a rewards expense associated with a credit card is $108, a cost of funds associated with a credit card is $105, and operating expenses associated with Customer A are $1,452. Consultant server 210 determines that the sum of the cost values, including the operating expenses, is $12,315 (not shown).

As shown, consultant server 210 determines that pre-tax historical customer value is $4,632 (e.g., $16,947−12,315=$4,632). Assume that a tax rate of 35% applies to the pre-tax historical customer value. As shown, a tax amount is $1,621 (e.g., $4,632×0.35). As shown, by subtracting $1,621 from $4,632, consultant server 210 determines that the historical customer value is $3,011. Consultant server 210 may use the historical customer value of Customer A to calculate the ACV of Customer A, as described in more detail elsewhere herein.

As indicated above, FIG. 7 is provided merely as an example. Other examples are possible and may differ from what was described with regard to FIG. 7.

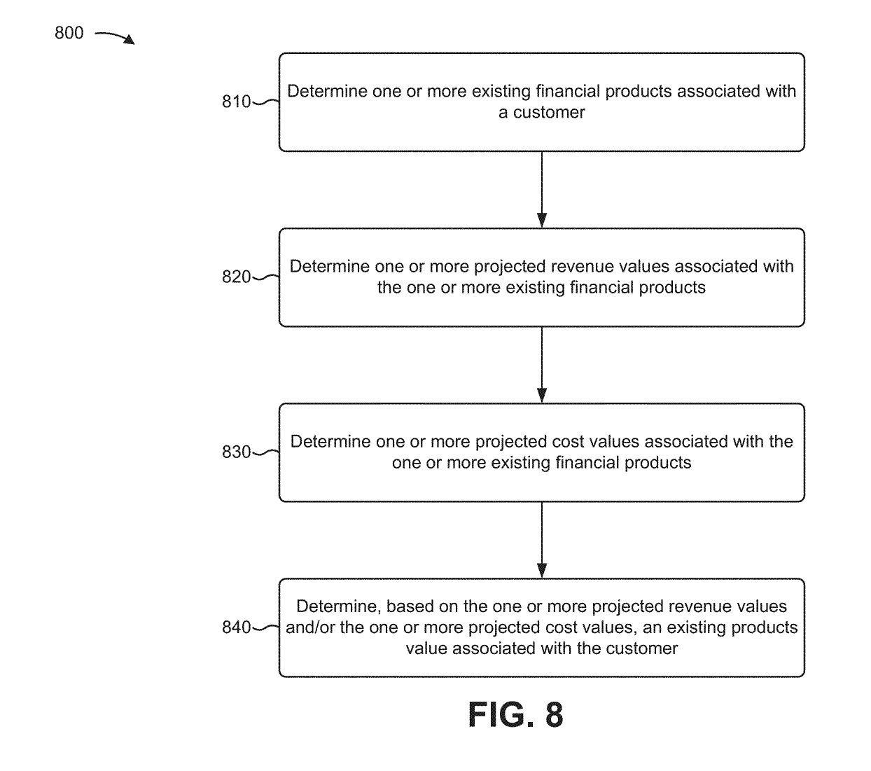

FIG. 8 is a flow chart of an example process 800 for determining an existing products value associated with a customer. In some implementations, one or more process blocks of FIG. 8 may be performed by consultant server 210. In some implementations, one or more process blocks of FIG. 8 may be performed by another device or a set of devices separate from or including consultant server 210, such as consultant user device 220 and/or bank server 230.

As shown in FIG. 8, process 800 may include determining one or more existing financial products associated with a customer (block 810). For example, consultant server 210 may determine one or more existing financial products associated with a customer by determining which financial products are held by a customer on the zero date. In some implementations, consultant server 210 may determine the one or more existing financial products based on financial information received from bank server 230. In some implementations, the one or more existing financial products may be used to calculate an existing products value, which may refer to a projected profit, during a projection period, associated with financial products held by the customer on the zero date.

As further shown in FIG. 8, process 800 may include determining one or more projected revenue values associated with the one or more existing financial products (block 820). For example, consultant server 210 may determine one or more projected revenue values associated with the one or more existing financial products. In some implementations, consultant server 210 may determine the one or more projected revenue values based on information, received from bank server 230, that identifies a revenue driver associated with a financial product and based on information that identifies a formula to calculate the revenue value associated with the revenue driver.

Additionally, or alternatively, consultant server 210 may determine a projection period for which projected revenue values are to be calculated. In some implementations, the projection period may start on the zero date and end on an end date of an aggregate time period (e.g., a projection period may be a time period of two years, five years, ten years, from this date to that date, or the like).

In some implementations, consultant server 210 may determine, for the projection period, customer retention rates (e.g., an average probability that a customer will remain with the bank in a particular time period), product-specific retention rates (e.g., an average probability that a customer will retain use of a specific financial product in a particular time period), and/or projected growth rates associated with a revenue value (e.g., a probabilistic estimate of a growth in a revenue value associated with a customer having characteristics similar to the customer), in order to determine the projected revenue values. In some implementations, retention rates may be related to an attrition rate by subtraction from one (e.g., a retention rate of 97% or 0.97 corresponds to an attrition rate of 1−0.97=0.03, or 3%). Additionally, or alternatively, retention rates, projected-growth rates, interest rates, and other figures described herein may be calculated on a yearly basis, a monthly basis, a daily basis, or the like.

In some implementations, consultant server 210 may determine the customer retention rates, for the projection period, based on past customer retention rates. For example, assume that the projection period is five years. In such an example, consultant server 210 may determine the customer retention rates, for the projection period, based on past customer retention rates covering a past five years. For example, to determine a customer retention rate associated with a first year of the projection period, consultant server 210 may divide a quantity of customers in year −4 by a quantity of customers (e.g., out of the quantity of customers in year −4, without considering new customers) in year −5. For example, assuming that a quantity of customers associated with the bank in January 2010 was 1000 and a quantity of customers associated with the bank in January 2011 was 970, then consultant server 210 may determine that a customer retention rate of a first year of a projection period (e.g., January 2015 to January 2016) is 0.97 or 97%. Additionally, or alternatively, to determine a customer retention rate associated with a second year of the projection period, consultant server 210 may divide a quantity of customers in year −3 by a quantity of customers in year −5. For example, assuming that a quantity of customers associated with the bank in January 2010 was 1000 and a quantity of customers associated with the bank in January 2012 was 940, then consultant server 210 may determine that a customer retention rate of a second year of a projection period (e.g., January 2016 to January 2017) is 0.94 or 94%.

The percentage of 94% may refer to an estimate by consultant server 210 that there is a 94% probability that a customer associated with a bank on the zero date will be associated with the bank two years later. In some implementations, consultant server 210 may determine a retention rate associated with a third year of the projection period, a fourth year of the projection period, and so on, using a process analogous to a process described above. In some implementations, consultant server 210 may calculate an average customer rate that assists in identifying an average quantity of customers during a year of the projection period. Additionally, or alternatively, consultant server 210 may calculate an average customer rate by taking an arithmetic mean of a starting customers rate of customers at a beginning of a year and a customer retention rate associated with the year. Additionally, or alternatively, consultant server 210 may truncate the average customer rate to two decimal points instead of rounding up, in order to avoid over-estimating the average quantity of customers. For example, assume that a customer retention rate is 0.97 for a first year. In such an example, an average customer rate associated with the first year is 0.98 because a starting customers rate is 1.0 and a retention rate is 0.97 [((1.0+0.97)/2)=0.98≈0.98 using truncation].

In some implementations, consultant server 210 may determine the product-specific retention rates, for the projection period, based on past product specific retention rates. For example, assume that the projection period is five years. In such an example, consultant server 210 may determine the product-specific retention rates, for the projection period, based on past product-specific retention rates covering a past five years. For example, to determine a product-specific retention rate associated with a first year of the projection period, consultant server 210 may divide a quantity of accounts associated with a financial product in year −4 by a quantity of accounts (e.g., out of the quantity of accounts in year −4) associated with the financial product in year −5 (e.g., the product specific retention rate associated with the first year may be 0.96). Additionally, or alternatively, to determine a product-specific retention rate associated with a second year of the projection period, consultant server may divide a quantity of accounts associated with a financial product in year −3 by a quantity of accounts associated with the financial product in year −5 (e.g., a product specific retention rate associated with a second year may be 0.92). In some implementations, consultant server 210 may determine a product-specific retention rate associated with a third year, a fourth year, and so on, using a process analogous to a process described above.

In some implementations, consultant server 210 may calculate an average product-specific rate that assists in identifying an average quantity of accounts associated with a financial product during a year of the projection period. Additionally, or alternatively, consultant server 210 may calculate an average product-specific rate by taking an arithmetic mean of a starting product-specific rate of customers at a beginning of a year and a product-specific retention rate associated with the year. Additionally, or alternatively, consultant server 210 may truncate the average product-specific rate to two decimal points instead of rounding up, in order to avoid over-estimating the average quantity of accounts associated with a financial product. For example, assume that a product specific retention rate is 0.96 for a first year and 0.92 for a second year. In such an example, an average product-specific rate associated with the second year is 0.94 because a starting product-specific rate is 0.96 and a product-specific retention rate associated with the second year is 0.92 [((0.96+0.92=)/2)=0.94]. In such an example, an average product-specific rate associated with the first year is 0.98 [((1.0+0.96=)/2)=0.98].

In some implementations, consultant server 210 may calculate a net product retention rate that may be used for calculating the projected revenue values for the projection period. Consultant server 210 may determine a net product retention rate associated with a year by identifying a higher value of the following two values: an average customer rate associated with the year and an average product specific rate associated with the year. For example, assuming that an average customer rate associated with a second year is 0.95 and assuming that an average product-specific rate associated with the second year is 0.94, the consultant server may determine that the net product retention rate associated with the second year is 0.95.

In some implementations, consultant server 210 may determine projected growth rates associated with a revenue value based on calculating an average of a revenue value at a segment-year level and based on past changes in the average of the revenue value at the segment-year level. In some implementations, a segment may refer to a group of customers that may be likely to behave in a similar way in relation to a bank (e.g., a segment based on age (e.g., 30 and under segment, a 31-49 segment, a 50 and above segment, or the like), a segment based on education (e.g., a high school graduate segment, a college graduate segment, or the like), a segment based on wealth or income (e.g., a high wealth segment, a low income segment, or the like), a segment based on geography (e.g., a Nebraska segment, a British segment, a Virginia segment, or the like), or a segment based on any other biographical, demographic, and/or statistical factor that may be useful in predicting a customer's behavior.

In some implementations, consultant server 210 may calculate an average of a revenue value at a segment-year level by dividing a sum of revenue values associated with accounts (e.g., including new accounts) included in a segment by a quantity of unique customers holding the accounts in a year. For example, assume that there are 1000 customers in a year, included in a Nebraska segment, with a single current account with an interest income of $90 and assume that there are 1000 customers in the year, included in the Nebraska segment, with a single current account with an interest income of $70. In such an example, consultant server 210 may determine that an average of a revenue value (e.g., interest income associated with a current account) is $80.

Additionally, or alternatively, consultant server 210 may calculate projected growth rates of a revenue value, for the projection period, based on past averages of the revenue value at a segment-year level. For example, assume that the projection period is five years. In such an example, consultant server 210 may determine the projected growth rates of a revenue value, for the projection period, based on past averages of the revenue value covering the past five years. For example, to determine a projected growth rate associated with a second year of the projection period and a Nebraska segment, consultant server 210 may divide an average of the revenue value in year −3 by an average of the revenue value in year −5. For example, assuming that an average of the revenue value in year −3 is $1530 and assuming that an average of the revenue value in year −5 is $1000, consultant server 210 may determine that an average growth rate of the revenue value in the second year is 53% or 1.53. In some implementations, consultant server 210 may determine a projected growth rate associated with a first year, a third year, and so on, using a process analogous to a process described above.

In some implementations, consultant server 210 may calculate the one or more projected revenue values associated with the one or more existing financial products based on net product retention rates and/or projected growth rates associated with the one or more projected revenue values. Additionally, or alternatively, consultant server 210 may calculate a revenue value associated with a year included in the projection period by multiplying the revenue value of the zero date with the net product retention rate associated with the year and with the projected growth rate associated with the year. For example, assume that interest income associated with a current account held by a customer has a value of $140 on the zero date. Assume further that a net product retention rate, associated with a second year of a projection period, associated with interest income of a current account, and associated with the customer is 0.95. Assume further that a projected growth rate associated with a second year of the projection period, associated with interest income of a current account, and associated with a segment that includes the customer is 1.53. In such an example, consultant server 210 may determine that the projected revenue value is $203 ($140×0.95×1.53=$203). In some implementations, the one or more projected revenue values may be used to determine the existing products value associated with a customer.

As further shown in FIG. 8, process 800 may include determining one or more projected cost values associated with the one or more existing financial products (block 830). For example, consultant server 210 may determine one or more projected cost values based on information, received from bank server 230, that identifies a cost driver associated with a financial product and based on information that identifies a formula to calculate the cost value associated with the cost driver. Additionally, or alternatively, consultant server 210 may calculate the one or more projected cost values for a projection period.

In some implementations, consultant server 210 may calculate the one or more projected cost values associated with the one or more existing financial products based on net product retention rates and/or projected growth rates associated with the one or more projected cost values (e.g., the net product retention rates and/or the projected growth rates may be calculated by consultant server 210 using a process analogous to a process used to calculate the net product retention rates and/or the projected growth rates for the one or more projected revenue values, as described above). Additionally, or alternatively, consultant server 210 may calculate a cost value associated with a year included in the projection period by multiplying the cost value of the zero date with the net product retention rate associated with the year and with the projected growth rate associated with the year. Additionally, or alternatively, consultant server 210 may calculate a projected cost value that is associated with multiple financial products (e.g., operating expenses associated with a customer) using a process analogous to a process used to calculate a projected cost value associated with a single financial product.

As further shown in FIG. 8, process 800 may include determining, based on the one or more projected revenue values and/or the one or more projected cost values, an existing products value associated with the customer (block 840). For example, consultant server 210 may determine, based on the one or more projected revenue values and/or the one or more projected cost values, an existing products value associated with a customer and with a projection period. In some implementations, consultant server 210 may determine the existing products value based on information, received from bank server 230, that identifies a tax rate and/or a discount factor associated with a year included in the projection period. Additionally, or alternatively, consultant server 210 may determine the existing products value based on information, received from bank server 230, that identifies a terminal value, associated with a customer and with an end of a projection period. In some implementations, a terminal value may include a residual value, to the bank, of one or more financial products held by the customer at the end of the projection period.

In some implementations, consultant server 210 may calculate a pre-tax existing products value associated with a year by subtracting a sum of the one or more projected cost values from a sum of the one or more projected revenue values (e.g., a pre-tax existing products value for a first year may be $430 if the sum of the one or more projected cost values is $25,232 and the sum of the one or more projected revenue values is $25,662). In some implementations, a positive value for the pre-tax existing products value may represent a net profit for a bank while a negative value may represent a net loss for the bank. Additionally, or alternatively, consultant server 210 may calculate a cash flow associated with the year by subtracting a tax amount from the pre-tax existing products value (e.g., at a tax rate of 35% or 0.35, a cash flow for a first year of a pre-tax existing products value of $430 may be $279, because $430×0.35=$151 and $430−$151=$279). Additionally, or alternatively, consultant server 210 may calculate a present value of the cash flow for a year by multiplying the cash flow with a discount factor (e.g., for a cash flow of $279 and a discount factor of 0.71, the present value of the cash flow is $279×0.71=$198).

In some implementations, consultant server 210 may sum present values of the cash flow associated with each year included in the projection period. Additionally, or alternatively, consultant server 210 may receive a terminal value associated with a customer that identifies a worth, to the bank, of a customer's financial products beyond the projection period. Additionally, or alternatively, consultant server 210 may determine a discounted terminal value by multiplying the terminal value with a discount factor associated with a last year of the projection period. Additionally, or alternatively, consultant server 210 may determine the existing products value of a customer by summing the discounted terminal value with the sum of the present values of the cash flow associated with each year included in the projection period. In some implementations, the existing products value of a customer may be used to determine the aggregate customer value of the customer.

In this way, consultant server 210 may calculate an existing products value, which may be used by consultant server 210 (e.g., in conjunction with a historical customer value and/or a new products value) to determine an aggregate customer value associated with a customer.

Although FIG. 8 shows example blocks of process 800, in some implementations, process 800 may include additional blocks, fewer blocks, different blocks, or differently arranged blocks than those depicted in FIG. 8. Additionally, or alternatively, two or more of the blocks of process 800 may be performed in parallel.

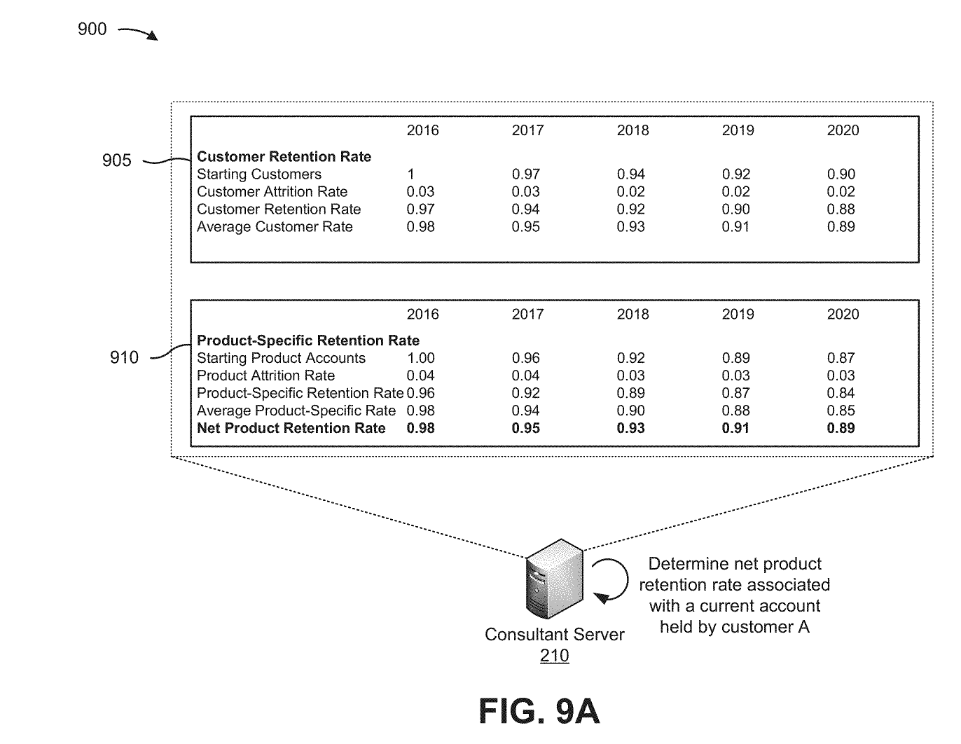

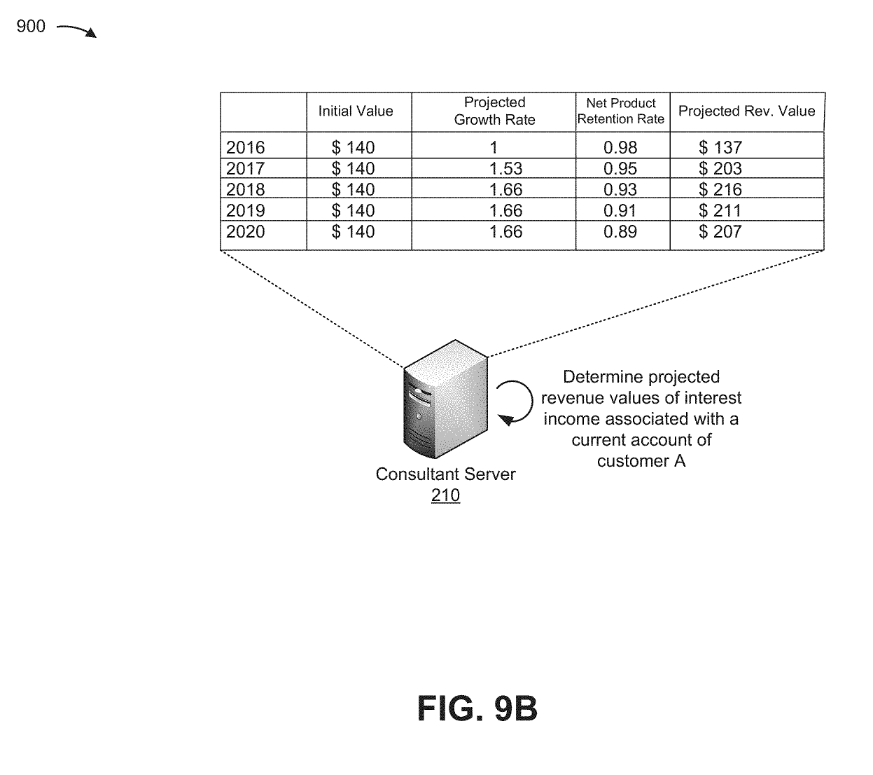

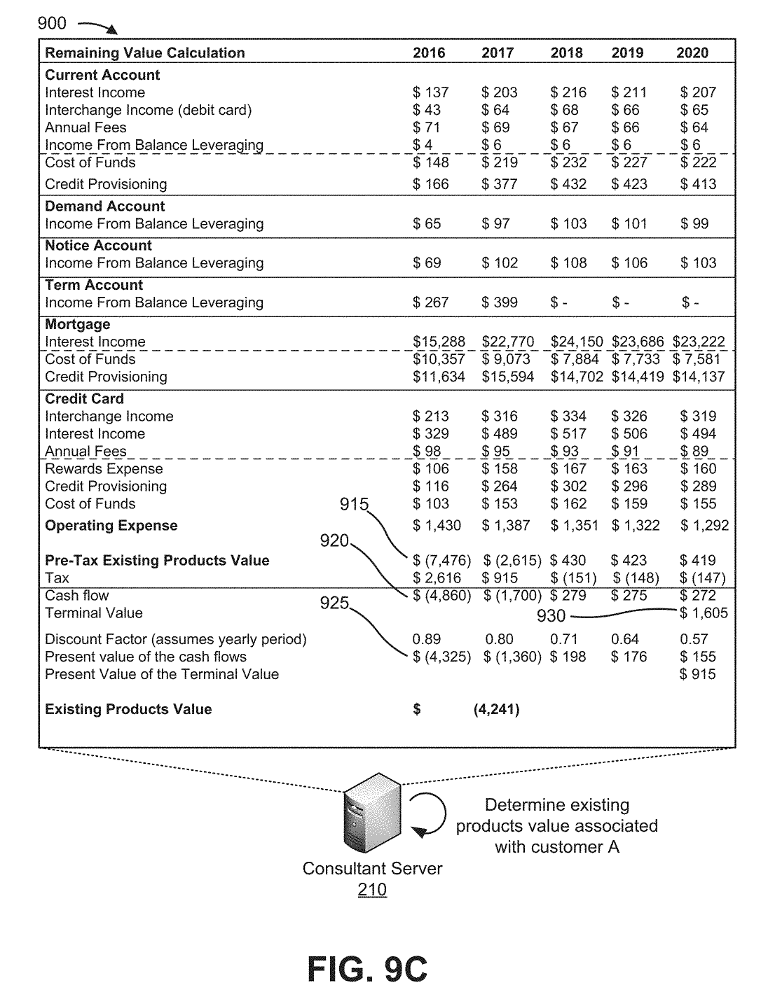

FIGS. 9A-9C are diagrams of an example implementation 900 relating to example process 800 shown in FIG. 8. FIGS. 9A-9C show an example of determining an existing products value associated with a customer.

As shown in FIG. 9A, assume that example implementation 900 includes consultant server 210 that has received financial information associated with determining an aggregate customer value and/or has received information that identifies a customer for whom the aggregate customer value is to be calculated (as described above in connection with FIG. 5A-5C). Assume further that Customer A is the customer for whom an ACV is to be calculated and that a start date of the aggregate period is Jan. 1, 2014, a zero date is Jan. 1, 2015, and an end date of the aggregate period is 01/01/2020.

Consultant server 210 determines existing financial products associated with Customer A. Assume that consultant server 210 determines that Customer A holds a current account, a demand account, a notice account, a term account, a mortgage, and a credit card. Consultant server 210 determines that a five year period starting on Jan. 1, 2015 and ending on Jan. 1, 2020 is the projection period for which projected revenue values, associated with the existing financial products, are to be calculated. In order to determine the projected revenue values (e.g., in FIG. 9A, interest income associated with a current account is the projected revenue value being determined by consultant server 210; consultant server 210 determines other revenue values in an analogous manner), consultant server 210 determines net product retention rates and projected growth rates.

As shown by reference number 905, consultant server 210 determines customer retention rates, associated with interest income of a current account, for the next five years based on customer retention rates from the past five years. As shown in a data structure stored by consultant server 210, consultant server 210 determines that the customer retention rate for 2016 (e.g., one year after the zero date) is 0.97, meaning that there is a 97% probability that Customer A will stay with the bank one year after the zero date. As further shown, consultant server 210 determines that the customer retention rate for 2017 is 0.94, the customer retention rate for 2018 is 0.92, and so on. As further shown, consultant server 210 determines that an average customer rate for 2016 is 0.98 [((1.0+0.97)/2)=0.98≈0.98 after truncation]. Consultant server 210 determines that an average customer rate for 2017 is 0.95, an average customer rate for 2018 is 0.93, and so on.

As shown by reference number 910, consultant server 210 determines product-specific retention rates, associated with interest income of a current account, for the next five years based on product-specific retention rates from the past five years. As shown, consultant server 210 determines that a product-specific retention rate for 2016 is 0.96, a product specific retention rate for 2017 is 0.92, and so on. As further shown, consultant server 210 determines that an average product-specific rate for 2016 is 0.98, than an average product-specific rate for 2017 is 0.94, and so on.

As further shown by reference number 910, consultant server 210 determines a net product retention rate by identifying a higher value of the following two values: an average customer rate associated with a year and an average product-specific rate associated with a year. As shown, consultant server 210 determines that a net product retention rate associated with 2016 is 0.98, that a net product retention rate associated with 2017 is 0.95, and so on. As shown in FIG. 9B, consultant server 210 determines projected growth rates, of interest income associated with a current account of Customer A, based on calculating an average of a revenue value at a segment-year level and based on past changes in the average of the revenue value at the segment-year level. As shown in a data structure stored by consultant server 210, consultant server 210 may determine that a projected growth rate associated with 2016 (e.g., a first year of a projection period) is 0% or 1.0, that a projected growth rate associated with 2017 is 53% or 1.53, that a projected growth rate associated with 2018 is 66% or 1.66 (e.g., 66% above an initial value of the revenue value ($140) at a time the ACV is calculated, not 66% year-on-year), and so on. As shown, net product retention rates are stored in the data structure (e.g., as the net product retention rates were determined in FIG. 9A). Consultant server 210 may calculate a projected revenue value associated with interest income of a current account by multiplying an initial value with a projected growth rate and with a net product retention rate (e.g., the projected revenue value of interest income in 2016 is $137 because $140×1×0.98=$137, the projected revenue value of interest income in 2017 is $203 because $140×1.53×0.93=$203, and so on).

Assume that consultant server 210 calculates, using a process analogous to a process described above, projected revenue values associated with other revenue values associated with current account (e.g., interchange income, annual fees, or the like) and other revenue values associated with other revenue drivers held by Customer A. Assume further that consultant server 210 calculates, using a process analogous to a process described above, projected cost values associated with the historical financial products held by Customer A (e.g., including operating expense).

As shown in FIG. 9C, assume that consultant server 210 determines, based on the projected revenue values and/or the projected cost values, an existing products value associated with Customer A (e.g., as shown in a data structure stored by consultant server 210). Assume that consultant server 210 received information, from bank server 230, that identifies a tax rate and/or a discount factor associated with a year included in the projection period.

As shown by reference number 915, consultant server 210 calculates a pre-tax existing products value associated with a year (e.g., 2016) by subtracting a sum of the projected cost values from a sum of the projected revenue values (e.g., as shown, a pre-tax existing products value for 2016 is −$7476 because the sum of the projected cost values is $24,060 and the sum of the projected revenue values is $16,584). A negative value for the pre-tax existing products value represents a net loss for a bank. As shown by reference number 920, consultant server 210 calculates a cash flow associated with 2016 by subtracting a tax amount from the pre-tax existing products value (e.g., assuming a tax rate of 35% or 0.35, a cash flow for a first year of a pre-tax existing products value of −$7,476 may be −$4,860, because $7,476×0.35=$2,616 and $7,476−$2,616=$4,860). Since, the pre-tax existing products value was negative (e.g., a loss), a tax of 35% actually represents a tax savings associated with a loss. A tax savings of $2,616 reduces the loss from a loss of $7,476 to a loss of $4,860.

As shown by reference number 925, consultant server 210 calculates a present value of the cash flow for a year by multiplying the cash flow with a discount factor (e.g., for 2016, a cash flow of −$4,860 and a discount factor of 0.89, the present value of the cash flow is −$4,860×0.89=−$4,325). Consultant server 210 may sum present values of the cash flow associated with each year included in the projection period.

As shown by reference number 930, consultant server 210 received a terminal value associated with a customer that identifies a worth, to the bank, of a customer's financial products beyond the projection period. Consultant server 210 determines a discounted terminal value (e.g., $915) by multiplying the terminal value (e.g., $1,605) with a discount factor associated with a last year of the projection period (e.g., 0.57). Consultant server 210 determines the existing products value of Customer A by summing the discounted terminal value with the sum of the present values of the cash flow associated with each year included in the projection period (e.g., the existing products value is −$4,241 because ($915)+(−$4,325)+(−1,360)+($198)+($176)+($155)=−$4,241). The existing products value of Customer A may be used to determine the aggregate customer value of Customer A.

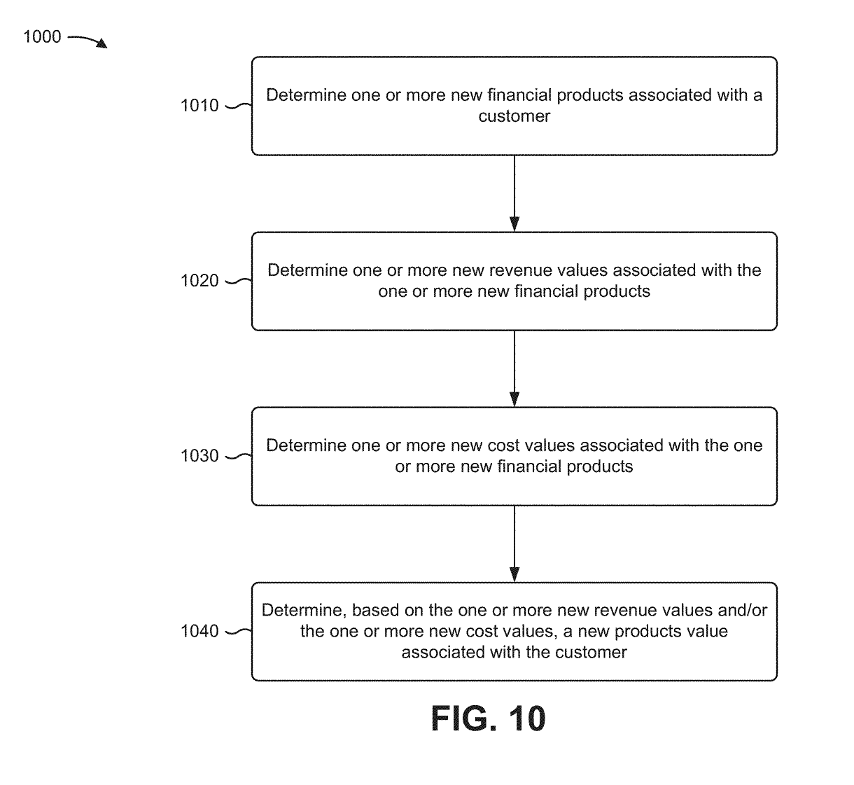

As indicated above, FIGS. 9A-9C are provided merely as an example. Other examples are possible and may differ from what was described with regard to FIGS. 9A-9C. FIG. 10 is a flow chart of an example process 1000 for determining a new products value associated with a customer. In some implementations, one or more process blocks of FIG. 10 may be performed by consultant server 210. In some implementations, one or more process blocks of FIG. 10 may be performed by another device or a set of devices separate from or including consultant server 210, such as consultant user device 220 and/or bank server 230.

As shown in FIG. 10, process 1000 may include determining one or more new financial products associated with a customer (block 1010). For example, consultant server 210 may determine one or more new financial products that a customer is likely to accept during a projection period. In some implementations, a new products value may refer to a projected profit, during the projection period, expected from a customer based on new financial products that the customer may acquire during the projection period. In some implementations, consultant server 210 may determine the one or more new financial products based on probabilistic calculations that are based on the following factors: a frequency with which a customer accepts new financial products (e.g., during a past time period), a frequency with which a member of a segment, to which the customer belongs, accepts new financial products, a frequency with which customers at other banks accept new financial products, a frequency with which customers accept new financial products in controlled or experimental environments, or the like. For example, consultant server 210 may determine that a customer is likely to accept an offer to open a demand account and keep the demand account active for three out of a five year projection period. In some implementations, consultant server 210's determination of the one or more new financial products associated with a customer is a preliminary determination (e.g., whether a customer actually accepts the one or more new financial products is determined based on a propensity score, as described below).

As further shown in FIG. 10, process 1000 may include determining one or more new revenue values associated with the one or more new financial products (block 1020). For example, consultant server 210 may determine one or more new revenue values associated with the one or more new financial products. In some implementations, consultant server 210 may determine the one or more new revenue values based on probabilistic calculations that are based on the following factors: an average revenue value associated with new financial products accepted by the customer (e.g., during a past time period), an average revenue value associated with new financial products accepted by a member of a segment to which the customer belongs, an average revenue value associated with a revenue driver of new financial products accepted by customers, or the like. For example, consultant server 210 may determine that income from balance leveraging of a demand account is likely to be $500 during a first year of a projection period.

In some implementations, consultant server 210 may determine one or more revenue values associated with a new financial product based on net product retention rates and/or projected growth rates (e.g., using a process analogous to a process used by consultant server 210 to determine one or more revenue values associated with an existing financial product). As further shown in FIG. 10, process 1000 may include determining one or more new cost values associated with the one or more new financial products (block 1030). For example, consultant server 210 may determine one or more new cost values associated with the one or more new financial products. In some implementations, consultant server 210 may determine the one or more new cost values based on probabilistic calculations that are based on the following factors: an average cost value associated with new financial products accepted by the customer (e.g., during a past time period), an average cost value associated with new financial products accepted by a member of a segment, to which the customer belongs, an average cost value associated with a cost driver of new financial products accepted by customers, or the like. For example, consultant server 210 may determine that additional operating expense associated with a demand account is likely to be $100 during a first year of a projection period.

In some implementations, consultant server 210 may determine one or more cost values associated with a new financial product based on net product retention rates and/or projected growth rates (e.g., using a process analogous to a process used by consultant server 210 to determine one or more cost values associated with an existing financial product). As further shown in FIG. 10, process 1000 may include determining, based on the one or more new revenue values and/or the one or more new cost values, a new products value associated with the customer (block 1040). For example, consultant server 210 may determine, based on the one or more new revenue values and/or the one or more new cost values, a new products value associated with a customer and with a projection period. In some implementations, consultant server 210 may determine the new products value based on information, received from bank server 230, that identifies a tax rate and/or a discount factor associated with a year included in the projection period. Additionally, or alternatively, consultant server 210 may determine the new products value based on information, received from bank server 230, that identifies a propensity score (e.g., a probability that a customer will accept a new financial product), associated with a customer.

In some implementations, consultant server 210 may calculate a pre-tax new products value associated with a year by subtracting a sum of the one or more new cost values from a sum of the one or more new revenue values (e.g., a pre-tax new products value for a first year may be $400 if the sum of the one or more new cost values is $600 and the sum of the one or more new revenue values is $1,000). Additionally, or alternatively, consultant server 210 may calculate a cash flow associated with a year by subtracting a tax amount from the pre-tax new products value (e.g., at a tax rate of 35% or 0.35, a cash flow for a first year of a pre-tax new products value of $400 may be $260, because $400×0.35=$140 and $400-$140=$260). Additionally, or alternatively, consultant server 210 may calculate a present value of the cash flow for a year by multiplying the cash flow with a discount factor (e.g., for a cash flow of $260 and a discount factor of 0.89, the present value of the cash flow is $260×0.89=$231).

In some implementations, consultant server 210 may sum present values of the cash flow associated with years included in the projection period. Additionally, or alternatively, consultant server 210 may determine the new products value of a customer by multiplying a propensity score with a sum of the present values of the cash flow associated with years included in the projection period (e.g., assuming a propensity score of 4% or 0.04 and assuming the sum of the present values of the cash flow is $2000, consultant server 210 would determine that the new products value is $80).

In this way, consultant server 210 may calculate a new products value, which may be used by consultant server 210 (e.g., in conjunction with a historical customer value and/or an existing products value) to determine an aggregate customer value associated with a customer.

Although FIG. 10 shows example blocks of process 1000, in some implementations, process 1000 may include additional blocks, fewer blocks, different blocks, or differently arranged blocks than those depicted in FIG. 10. Additionally, or alternatively, two or more of the blocks of process 1000 may be performed in parallel.

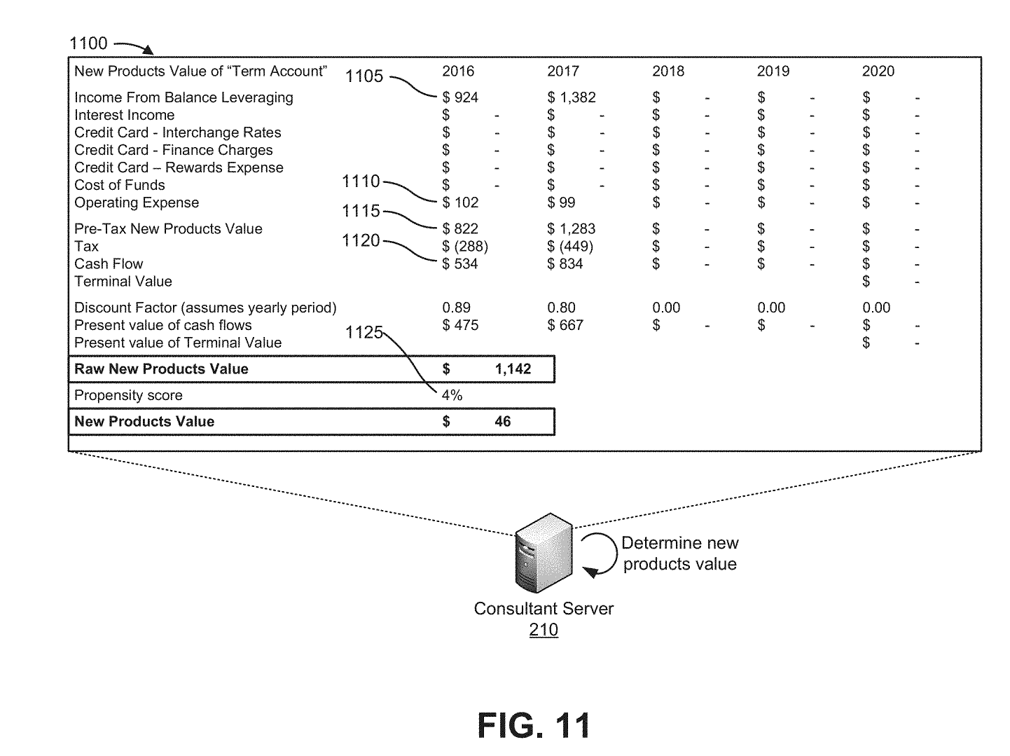

FIG. 11 is a diagram of an example implementation 1100 relating to example process 1000 shown in FIG. 10. FIG. 11 shows an example of determining a new products value associated with a customer.

As shown in FIG. 11, assume that example implementation 1100 includes consultant server 210 that has received financial information associated with determining an aggregate customer value and/or has received information that identifies a customer for whom the aggregate customer value is to be calculated (as described above in connection with FIG. 5A-5C). Assume further that Customer A is the customer for whom an ACV is to be calculated and that a start date of the aggregate period is Jan. 1, 2014, a zero date is Jan. 1, 2015, and an end date of the aggregate period is Jan. 1, 2020. Assume that consultant server 210 determines that term account is a new financial product that Customer A is likely to accept during a projection period.

As shown by reference number 1105, consultant server 210 determines new revenue values associated with the new financial product (e.g., income from balance leveraging has a new revenue value of $924 in 2016). Consultant server 210 determines the new revenue values based on probabilistic calculations that are based on an average revenue value associated with new financial products accepted by Customer A (e.g., during a past time period). As further shown, consultant server 210 determines a new revenue value associated with income from balance leveraging for 2017 (e.g., $1,382) based on net product retention rates and/or projected growth rates.

As shown by reference number 1110, consultant server 210 determines new cost values associated with operating expense of a term account (e.g., $102). Consultant server 210 determines new cost values based on probabilistic calculations that are based on an average cost value associated with new financial products accepted by the customer (e.g., during a past time period). As further shown, consultant server determines a new cost value associated with operating expense for 2017 (e.g., $99) based on net production retention rates and/or projected growth rates.

Assume that consultant server 210 received, from bank server 230, information that identifies a tax rate and a discount factor associated with a year included in the projection period. Assume further that consultant server 210 received, from bank server 230, information that identifies a propensity score (e.g., a probability that Customer A will accept a new financial product), associated with Customer A.

As shown by reference number 1115, consultant server 210 calculates a pre-tax new products value associated with a year by subtracting a sum of the new cost values from a sum of the new revenue values (e.g., a pre-tax new products value for 2016 may be $822 if the sum of the new cost values is $102 and the sum of the new revenue values is $924). As shown by reference number 1120, consultant server 210 calculates a cash flow associated with a year by subtracting a tax amount from the pre-tax new products value (e.g., at a tax rate of 35% or 0.35, a cash flow for 2016 is $534, because $822×0.35=$288 and $822−$288=$534). Consultant server 210 calculates a present value of the cash flow for a year by multiplying the cash flow with a discount factor (e.g., for 2016, the discount factor is 0.89 and the present value of the cash flow is $534×0.89=$475).

Consultant server 210 sums present values of the cash flow associated with years included in the projection period to determine a raw new products value (e.g., $475+$667=$1,142). Consultant server 210 determines the new products value by multiplying a propensity score (e.g., as shown by reference number 1125, the propensity score is 4% or 0.04) with the raw new products value. Consultant server 210 determines that the new products value of Customer A is $46 because 0.04×$1,142=$46.

As indicated above, FIG. 11 is provided merely as an example. Other examples are possible and may differ from what was described with regard to FIG. 11.

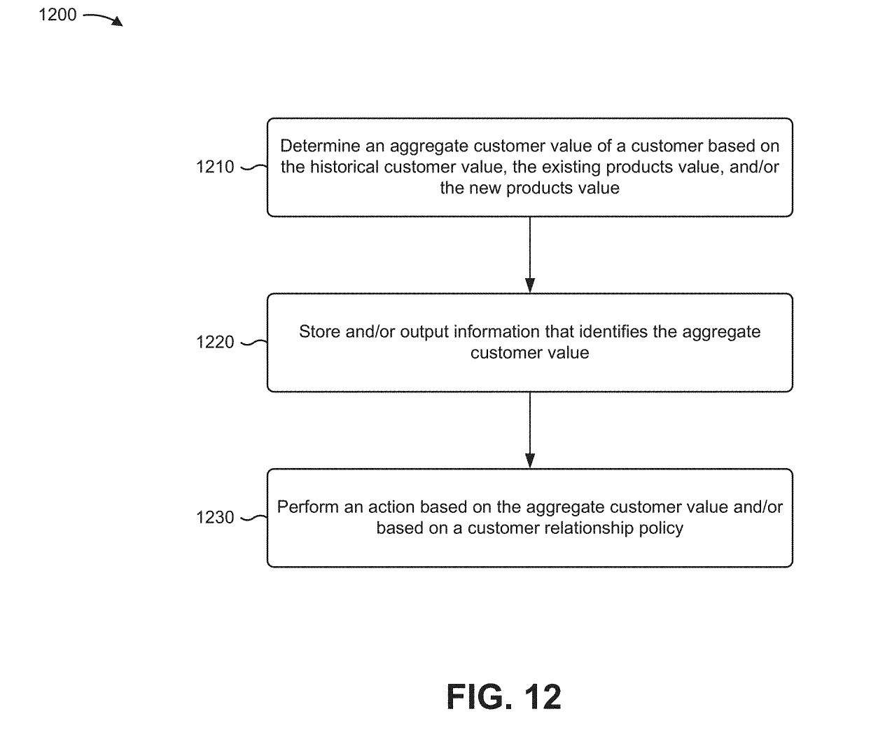

FIG. 12 is a flow chart of an example process 1200 for determining an aggregate customer value associated with a customer and/or performing an action based on the aggregate customer value. In some implementations, one or more process blocks of FIG. 12 may be performed by consultant server 210. In some implementations, one or more process blocks of FIG. 12 may be performed by another device or a set of devices separate from or including consultant server 210, such as consultant user device 220 and/or bank server 230.

As shown in FIG. 12, process 1200 may include determining an aggregate customer value of a customer based on the historical customer value, the existing products value, and/or the new products value (block 1210). For example, consultant server 210 may determine the aggregate customer value of a customer by combining the historical customer value (HCV), the existing products value (EPV), and/or the new products value (NPV) associated with the customer. In some implementations, combining the HCV, the EPV, and/or the NPV may include: summing the HCV, the EPV, and/or the NPV; applying weights to the HCV, the EPV, and/or the NPV, and then summing a weighted HCV, a weighted EPV, and/or a weighted NPV; taking a product of the HCV, the EPV, and/or the NPV; or the like.

As further shown in FIG. 12, process 1200 may include storing and/or outputting information that identifies the aggregate customer value (block 1220). For example, consultant server 210 may store information that identifies the aggregate customer value and/or provide, to consultant user device 220 and/or bank server 230, information that identifies the aggregate customer value. In some implementations, consultant user device 220 and/or a display device associated with bank server 230 may display information that identifies a customer and the aggregate customer value associated with the customer.

In some implementations, consultant server 210 may provide, to consultant user device 220 and/or bank server 230, information that identifies calculations used to determine the aggregate customer value. Additionally, or alternatively, consultant user device 220 and/or a display device associated with bank server 230 may display information that identifies the historical customer value, the existing products value, and/or the new products value associated with the customer. In some implementations, consultant user device 220 and/or a display device associated with bank server 230 may display calculations used to determine the historical customer value, the existing products value, and/or the new products value.

As further shown in FIG. 12, process 1200 may include performing an action, based on the aggregate customer value and/or based on a customer relationship policy (block 1230). For example, consultant server 210 may perform an action, such as automatically providing an offer to an e-mail account of a customer, based on the aggregate customer value and/or based on a customer relationship policy. In some implementations, consultant server 210 may cause the action to be performed by, for example, transmitting a message (e.g., to another device) that triggers the action, providing an instruction (e.g., to another device) that triggers the action, triggering the action by consultant server 210, or the like. In some implementations, a customer relationship policy may identify a set of actions that are to be performed in relation to a customer if the customer's aggregate customer value satisfies a threshold (e.g., the customer relationship policy may be stored by consultant server 210).

For example, the customer relationship policy may identify an automatic sending of a promotional e-mail to a customer's e-mail account (e.g., the action) if a customer has an aggregate customer value (e.g., the criteria) that satisfies a threshold. In such an example, consultant server 210 may instruct bank server 230 to send a promotional e-mail to a customer that has an aggregate customer value that satisfies the threshold. Additionally, or alternatively, consultant server 210 may not instruct bank server 230 to send the promotional e-mail if the customer's ACV does not satisfy the threshold (e.g., a bank may use computer and/or human resources more efficiently by not wasting time on customers that have low ACVs, thus increasing profitability).

As another example, the customer relationship policy may include: an automatic providing of a benefit (e.g., a better interest rate, lower fees, rewards cash, rewards points, priority access to bank customer service, access to a larger quantity of financial products, or the like) to a customer if a customer has an aggregate customer value that satisfies a threshold. In such an example, consultant server 210 may instruct bank server 230 to provide the benefit to a customer that has an aggregate customer value that satisfies the threshold. In some implementations, bank server 230 may provide the benefit to the customer by providing notification e-mails to the customer's e-mail account (e.g., the notification e-mails may require a customer's approval before any changes are made to the customer's account information) and/or by making changes to the customer's account information to reflect the benefit.

In this way, consultant server 210 may determine an aggregate customer value at a level of an individual customer and using channel-level cost distribution. With a proper understanding of evolving customer needs based on the aggregate customer value, the bank may reduce customer attrition and/or efficiently use the bank's marketing resources in targeting customers—thereby improving the bank's profitability.

Although FIG. 12 shows example blocks of process 1200, in some implementations, process 1200 may include additional blocks, fewer blocks, different blocks, or differently arranged blocks than those depicted in FIG. 12. Additionally, or alternatively, two or more of the blocks of process 1200 may be performed in parallel.

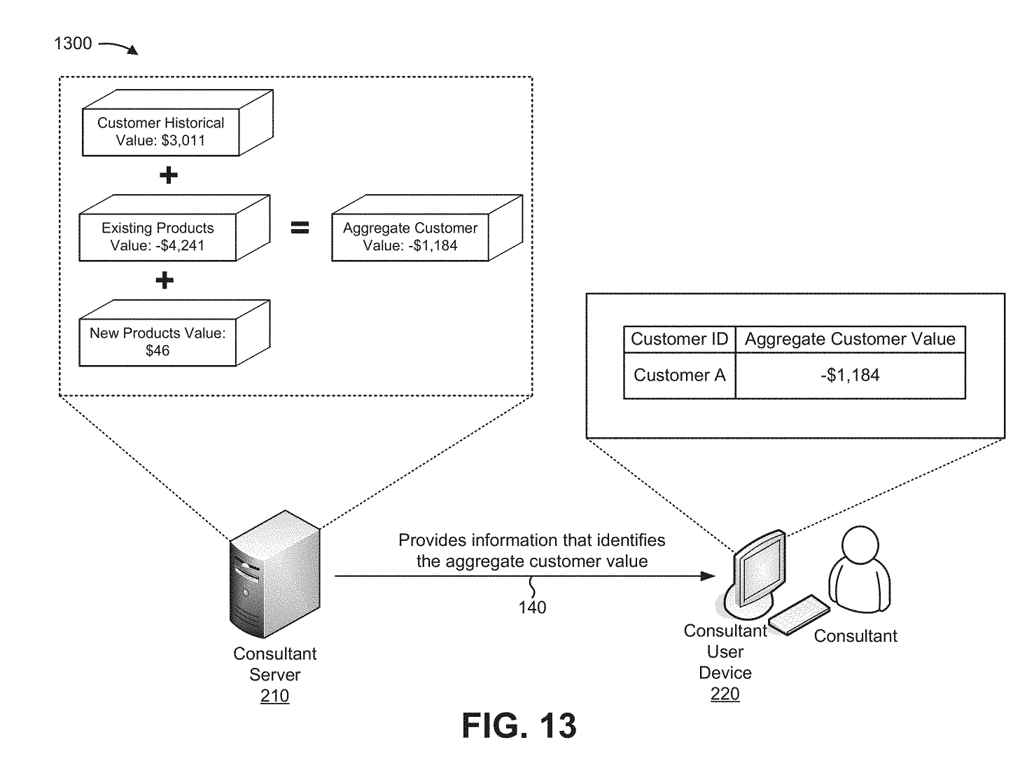

FIG. 13 is a diagram of an example implementation 1300 relating to example process 1200 shown in FIG. 12. FIG. 13 shows an example of determining an aggregate customer value associated with a customer and/or performing an action based on the aggregate customer value.

As shown in FIG. 13, assume that example implementation 1300 includes consultant server 210 that has received financial information associated with determining an aggregate customer value and/or has received information that identifies a customer for whom the aggregate customer value is to be calculated (as described above in connection with FIG. 5A-5C). Assume further that Customer A is the customer for whom ACV is to be calculated and that a start date of the aggregate period is Jan. 1, 2014, a zero date is Jan. 1, 2015, and an end date of the aggregate period is Jan. 1, 2020. Assume that consultant server 210 determines that term account is a new financial product that Customer A is likely to accept during a projection period. Assume further that consultant server 210 has determined that a customer historical value associated with Customer A is $3,011 (e.g., as shown in FIG. 7), that an existing products value associated with Customer A is −$4,241 (e.g., as shown in FIG. 9C), and that a new products value associated with Customer A is $46 (e.g., as shown in FIG. 11).

As shown in FIG. 13, consultant server 210 determines that the aggregate customer value associated with Customer A is −$1,184 by summing the customer historical value, the existing products value, and the new products value. Consultant server 210 stores information that identifies the ACV of Customer A. As further shown, consultant server 210 provides information that identifies the ACV of Customer A to consultant user device 220, which may display the ACV of Customer A on a user interface. Assume that a customer relationship policy included providing an instruction, to send a promotional e-mail to Customer A's e-mail account, to bank server 230 (not shown) if a customer's ACV is above zero. Consultant server 210 does not provide the instruction to bank server 230 because the customer's ACV is negative (e.g., a bank does not want to waste resources on a customer that is a net loss to the bank).

As indicated above, FIG. 13 is provided merely as an example. Other examples are possible and may differ from what was described with regard to FIG. 13.

In this way, the consultant server may determine an aggregate customer value at a level of an individual customer and using channel-level cost distribution. With a proper understanding of evolving customer needs based on the aggregate customer value, the bank may reduce customer attrition and/or efficiently use the bank's marketing resources in targeting customers—thereby improving the bank's profitability.

The foregoing disclosure provides illustration and description, but is not intended to be exhaustive or to limit the implementations to the precise form disclosed. Modifications and variations are possible in light of the above disclosure or may be acquired from practice of the implementations.

As used herein, the term component is intended to be broadly construed as hardware, firmware, and/or a combination of hardware and software.

Some implementations are described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, etc.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware can be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Furthermore, as used herein, the terms “set” and “group” are intended to include one or more items (e.g., related items, unrelated items, a combination of related and unrelated items, etc.), and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

1. A device, comprising:
a memory to store first information that identifies:
financial products held by a customer, and
other financial products; and
one or more processors, coupled to the memory, to:
receive second information that identifies the customer and that identifies a start date, a zero date, and an end date;
calculate, based on the first information, a historical customer value that is an actual profit generated by the customer during a first time period extending from the start date to the zero date;
calculate, based on the first information, an existing products value that is a first projected profit, associated with the financial products held by the customer on the zero date, projected to be generated by the customer during a second time period extending from the zero date to the end date;
calculate, based on the first information, a new products value that identifies a second projected profit, associated with the other financial products that the customer is likely to accept during the second time period, projected to be generated by the customer during the second time period;
calculate an aggregate customer value associated with the customer based on the historical customer value, the existing products value, and the new products value;
identify, based on the aggregate customer value, an action to be performed in connection with the customer; and
transmit, to another device and via a network, an instruction that causes the action to be performed by the other device.

2. The device of claim 1, where the one or more processors are further to:
determine whether the aggregate customer value satisfies a threshold; and
transmit the instruction based on the aggregate customer value satisfying the threshold,
the instruction instructing the other device to provide rewards points to an account associated with the customer.

3. The device of claim 1, where the one or more processors are further to:
determine one or more financial products held by the customer on the zero date;
calculate one or more projected revenue values associated with the one or more financial products,
the one or more projected revenue values being projected for the second time period based on a retention rate and based on a projected growth rate,
the retention rate being a probability of the customer retaining use of a financial product, of the one or more financial products, and being determined based on a past retention rate, associated with the customer, during a past time period,
the projected growth rate being a probable growth of a revenue value, of the one or more projected revenue values, and being determined based on a growth of the revenue value during a past time period;
calculate one or more projected cost values associated with the one or more financial products; and
calculate the existing products value based on the one or more projected revenue values and based on the one or more projected cost values.

4. The device of claim 1, where the one or more processors are further to:
determine one or more financial products that the customer is likely to accept during the second time period;
calculate one or more new revenue values associated with the one or more financial products based on an average of past values of one or more revenue drivers associated with the one or more new revenue values;
calculate one or more new cost values associated with the one or more financial products;
calculate a propensity score, associated with the customer, that identifies a probability that the customer will accept a financial product of the one or more financial products; and
calculate the new products value based on the one or more new revenue values, based on the one or more new cost values, and based on the propensity score.

5. The device of claim 1, where the one or more processors are further to:
combine the historical customer value, the existing products value, and the new products value
to calculate the aggregate customer value.

6. The device of claim 1, where the one or more processors are further to:
receive third information that identifies a customer relationship policy,
the customer relationship policy identifying the action and a threshold;
determine whether the aggregate customer value satisfies the threshold; and
transmit the instruction that causes the action to be performed based on the aggregate customer value satisfying the threshold.

7. The device of claim 1,
where the zero date is a date on which the aggregate customer value is being calculated;
where the start date marks a beginning of a third time period,
the third time period being a time period for which the aggregate customer value is to be calculated; and
where the end date marks an end of the third time period.

8. A computer-readable medium storing instructions, the instructions comprising:
one or more instructions that, when executed by one or more processors of a device, cause the one or more processors to:
store first information that identifies:
financial products held by a customer, and
other financial products;
receive second information that identifies the customer and that identifies a start date, a zero date, and an end date;
calculate, based on the first information, a historical customer value that is an actual profit generated by the customer during a first time period extending from the start date to the zero date;
calculate, based on the first information, an existing products value that is a first projected profit, associated with the financial products held by the customer on the zero date, projected to be generated by the customer during a second time period extending from the zero date to the end date;
calculate, based on the first information, a new products value that identifies a second projected profit, associated with the other financial products that the customer is likely to accept during the second time period, projected to be generated by the customer during the second time period;
calculate an aggregate customer value associated with the customer by combining the historical customer value, the existing products value, and the new products value;
identify, based on the aggregate customer value, an action to be performed in connection with the customer; and
selectively provide, to another device and via a network, an instruction to cause the action to be performed by the other device.

9. The computer-readable medium of claim 8, where the instructions further comprise:
one or more instructions that, when executed by the one or more processors cause the one or more processors to:
determine whether the aggregate customer value satisfies a threshold; and
selectively provide the instruction to the other device based on whether the aggregate customer value satisfies the threshold,
the action including providing priority access, to customer service, to the customer.

10. The computer-readable medium of claim 8, where the instructions further comprise:
one or more instructions that, when executed by the one or more processors, cause the one or more processors to:
determine a discount factor associated with a time period included in the second time period; and
calculate the existing products value based on the discount factor.

11. The computer-readable medium of claim 8, where the instructions further comprise:
one or more instructions that, when executed by the one or more processors, cause the one or more processors to:
determine a discount factor associated with a time period included in the second time period; and
calculate the new products value based on the discount factor.

12. The computer-readable medium of claim 8, where the instructions further comprise:
one or more instructions that, when executed by the one or more processors, cause the one or more processors to:
determine a tax rate associated with a time period included in the first time period; and
calculate the historical customer value based on the tax rate.

13. The computer-readable medium of claim 8, where the instructions further comprise:
one or more instructions that, when executed by the one or more processors, cause the one or more processors to:
receive third information that identifies a customer relationship policy,
the customer relationship policy identifying the action and a threshold;
determine whether the aggregate customer value satisfies the threshold; and
selectively provide the instruction based on whether the aggregate customer value satisfies the threshold.

14. The computer-readable medium of claim 8, where the instructions further comprise:
one or more instructions that, when executed by the one or more processors, cause the one or more processors to:
determine one or more historical financial products held by the customer during the first period;
calculate one or more historical revenue values associated with the one or more historical financial products and associated with the first period;
calculate one or more historical cost values associated with the one or more historical financial products and associated with the first period,
the one or more historical cost values including operating expenses; and
calculate, based on the one or more historical revenue values and the one or more historical cost values, the historical customer value.

15. A method, comprising:
storing, by a device, first information that identifies:
financial products held by a customer, and
other financial products;
receiving, by the device, second information that identifies the customer and that identifies a start date, a zero date, and an end date;
calculating, by the device and based on the first information, a historical customer value that is an actual profit generated by the customer during a first time period extending from the start date to the zero date;
calculating, by the device and based on the first information, an existing products value that is a first projected profit, associated with the financial products held by the customer on the zero date, projected to be generated by the customer during a second time period extending from the zero date to the end date;
calculating, by the device and based on the first information, a new products value that identifies a second projected profit, associated with financial products that the customer is likely to accept during the second time period, projected to be generated by the customer during the second time period;
calculating, by the device, an aggregate customer value associated with the customer based on the historical customer value, the existing products value, and the new products value;
identifying, by the device and based on the aggregate customer value, an action to be performed in connection with the customer; and
transmitting, by the device and to another device, via a network, an instruction to cause an action to be performed by the other device.

16. The method of claim 15, further comprising:
determining one or more financial products held by the customer on the zero date;
calculating one or more projected revenue values associated with the one or more financial products,
the one or more projected revenue values being projected for the second time period based on a retention rate and based on a projected growth rate,
the retention rate being a probability of the customer retaining use of a financial product, of the one or more financial products, and being determined based on a past retention rate, associated with the customer, during a past time period,
the projected growth rate being a probable growth of a revenue value, of the one or more projected revenue values, and being determined based on a growth of the revenue value during a past time period;
calculating one or more projected cost values associated with the one or more financial products; and
calculating the existing products value based on the one or more projected revenue values and based on the one or more projected cost values.

17. The method of claim 15, further comprising:
determining one or more financial products that the customer is likely to accept during the second time period;
calculating one or more new revenue values associated with the one or more financial products based on an average of past values of one or more revenue drivers associated with the one or more new revenue values;
calculating one or more new cost values associated with the one or more financial products;
calculating a propensity score, associated with the customer, that identifies a probability that the customer will accept a financial product of the one or more financial products; and
calculating the new products value based on the one or more new revenue values, based on the one or more new cost values, and based on the propensity score.

18. The method of claim 15, further comprising:
identifying a frequency with which the customer uses a particular medium of communication to interact with an entity that provides the first information; and
calculating the historical customer value based on the frequency.

19. The method of claim 15, further comprising:
combining the historical customer value, the existing products value, and the new products value
to calculate the aggregate customer value.

20. The method of claim 15, further comprising:
determining whether the aggregate customer value satisfies a threshold; and
transmitting the instruction based on the aggregate customer value satisfying the threshold,
the instruction instructing the other device to provide a promotional e-mail to the customer.
